(19) United States
(12) Patent Application Publication
(10) Pub. No.: US 2006/0045381 A1
(43) Pub. Date: Mar. 2, 2006

(54) Image processing apparatus, shooting apparatus and image display apparatus

(75) Inventors: Yoshihiro Matsuo, Hashima-shi (JP); Tsuyoshi Watanabe, Gifu-shi (JP); Shigeyuki Okada, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/212,609

(22) Filed: Aug. 29, 2005

(30) Foreign Application Priority Data
Aug. 31, 2004 (JP) 2004-251700
Sep. 29, 2004 (JP) 2004-284374

(51) Int. Cl. G06K 9/36

(52) U.S. Cl. 382/276

(57) ABSTRACT

An image processing apparatus and a shooting apparatus are provided that enable a user to recognize in real time image qualities of a plurality of regions while encoding an image in such a manner that a plurality of the regions have different image qualities. When a camera is in a shooting mode, an image transformation unit transforms an image in such a manner that the image quality level of each region set by a ROI region setting unit and an image quality setting unit can be visually recognized and generates in real time a through image to be displayed on a display device. A through image generated by the image transformation unit is sent to a display circuit via a switch and displayed on the display device.

### BACKGROUND OF THE INVENTION

1. Field of the Invention

The present invention relates to an image processing apparatus and a shooting apparatus, particularly for encoding each region in an image in a different image quality. The present invention further relates to an image display apparatus, particularly for making a region of interest to be displayed stand out.

2. Description of the Related Art

At ISO/ITU-T, JPEG2000 using a discrete wavelet transform (DWT) is being standardized as a successor to JPEG (Joint Photographic Expert Group), which is a standard technology for compression and coding of still images. In JPEG2000, a wide range of image quality, from low bit-rate coding to lossless compression, can be coded highly efficiently, and a scalability function, in which the image quality is gradually raised, can be realized easily. Moreover, JPEG2000 comes with a variety of functions which the conventional JPEG standard did not have.

As one of the functions of JPEG2000, the ROI (Region-of-Interest) coding is standardized, in which a region of interest of an image is coded and transferred in preference to other regions. Because of the ROI coding, when the coding rate has an upper limit, the reproduced image quality of a region of interest can be raised preferentially, and also when a codestream is decoded in sequence, a region of interest can be reproduced earlier with high quality.

Reference (1) discloses a technology for automatically recognizing a plurality of ROI regions in image data. According to Reference (1), as described in the paragraphs 0060 to 0061, the ROI region recognized automatically can be superimposed on the image shot by a shooting unit and then be displayed by a display unit. Furthermore, a user can select or discard the displayed ROI candidates and enlarge or reduce the ROI region.

Reference (2) discloses a technology for performing an image processing such as noise reduction and edge enhancement to improve an image quality when a coded image is decoded. More concretely, a reference image is formed in such a manner that the transform coefficients included in sub-bands other than LL sub-band are assumed to be 0. The region in the reference image corresponding to the transform coefficients in the sub-bands is obtained and the average of the pixel values in this region is obtained. If this average is smaller than a predetermined threshold, a threshold process is performed on these transform coefficients.

However, according to Reference (1), although a range of the ROI region is displayed on the displaying unit, a user cannot recognize any difference in image quality between the ROI region and the other regions. Therefore, it is impossible for the user to adjust the image quality while confirming the image quality of each region on the display unit before shooting or during shooting.

According to Reference 2, since the above-mentioned process is performed on the transform coefficients in sub-bands other than the LL sub-band, the amount of the operation increases greatly. Moreover, it is difficult to produce difference in image quality between regions in the image to an extent in which a certain region is made stand out.

2. Related Art List
(1) Japanese Patent Application Laid-Open No. 2004-72655.
(2) Japanese Patent Application Laid-Open No. 2002-135593.

### SUMMARY OF THE INVENTION

The present invention has been made in view of the foregoing circumstances and problems, and an object thereof is to provide an image processing apparatus and a shooting apparatus that enable a user to recognize in real time image quality of a plurality of regions while encoding an image in such a manner that a plurality of the regions have different image qualities. Another object of the present invention is to provide an image display apparatus capable of easily making a region of interest stand out.

A preferred embodiment according to the present invention relates to an image processing apparatus. This apparatus comprises: a region setting unit which sets a plurality of regions in an image; an encoding unit which encodes data of the image in such a manner that each of the regions set by the region setting unit has a different image quality; an image transformation unit which transforms the data of the image by performing a predetermined processing on the data of the image, a degree of the transformation being determined for each of the regions according to a level of the image quality of each of the regions encoded by the encoding unit; and a display unit which displays on a display device the data of the image transformed by the image transformation unit.

Here, the predetermined processing to be performed on the image implies a processing for transforming into a new image data that is different from the original image data, for instance, filtering, multiplication by a coefficient, or substitution with a constant value.

The degree of the transformation indicates how the generated image data is different form the original image data, and the degree of the transformation of each region is determined by adjusting a parameter that determines the degree of the transformation in the above-mentioned predetermined processing. This parameter indicates a magnitude of a filer coefficient for filtering, a magnitude of a multiplication coefficient for a multiplication process, a ratio of pixels to be substituted with a constant value. The degree of the transformation may be determined to be lower for the region with a higher level of image quality and to be higher for the region with a lower level of image quality.

This embodiment comprises the image transformation unit as well as the encoding unit. Therefore, when the encoding unit encodes an image in such a manner that each of a plurality of regions has a different image quality, the image transformation unit can generate in a simplified manner and in real time an image in which the image quality level of each of the regions in a coded image data can be visually recognized. Moreover, a user can view the image generated by the image transformation unit on a display device, and can immediately confirm the image quality level of a plurality of regions obtained by the encoding.

The apparatus may further comprise a decoding unit which decodes a coded data obtained by the encoding unit; and a selecting unit which selects the data of the image transformed by the image transformation unit to be input to the display unit, when the encoding unit encodes the image, and selects the data of the image decoded by the decoding unit to be input to the display unit, when the decoding unit decodes the coded data, wherein when the decoded image data is input to the display unit, the display unit may display the image data on the display device. By this, since a user can view in the display device an image that has been decoded from the coded data, the user can also confirm the image quality of the actual coded data.

The apparatus may further comprise a motion detection unit which detects movement of an object of interest in the image, wherein the region setting unit may make a region containing the object follow the movement of the object. By this, a user can confirm in real time a position or the like of an automatically following region by an image displayed on the display device.

The apparatus may further comprise an operation unit which enables a user to set at least one of position, size and image quality of the plurality of the regions. By this, the user can adjust position, size, or image quality of each of the regions while confirming the image displayed on the display device.

The image transformation unit may transform the data of the image in such a manner that each of the regions has a different image quality. A precise adjustment of image quality is not required for the image transformation unit compared with that required for the encoding, and the image transformation unit can make the image quality of each region different from each other by a simple processing. Moreover, an image obtained by the image transformation unit is close to an image obtained by the encoding. Therefore, by displaying on the display device the image obtained by this simple process in the image transformation unit, a user can recognize in real time the image quality level of each region in the coded image and also recognize how an image appears when it is decoded.

The image transformation unit may transform the data of the image in such a manner that each of the regions has a different color. By this, since the difference of image quality of each region when it is encoded is displayed as difference in color, the displayed image is clearly displayed in all regions. Therefore, a user can recognize in real time the image quality level of each region in the coded image and also recognize the contents in the entire image in all regions.

The image transformation unit may transform the data of the image in such a manner that each of the regions has a different brightness. Since human eyes are sensitive to a change in brightness, a user can recognize a slight difference in brightness. Therefore, even if the display device is low resolution or monochrome, by displaying an image each region of which has a different brightness on the display device, a user can easily recognize the image quality level of each region when it is encoded.

The image transformation unit may include a means for shading on the image and may transform the data of the image in such a manner that each of the regions has a different shading density. Since the shading can be realized by substituting the image data at a constant interval of pixels, it can be implemented easily. Therefore, the image processing apparatus can be realized at a low cost, which enables a user to recognize an image quality level of each region of a coded image.

Another preferred embodiment according to the present invention relates to a shooting apparatus. The apparatus comprises: a shooting unit which takes in an image; a region setting unit which sets a plurality of regions in the image; an encoding unit which encodes data of the image output from the shooting unit in such a manner that each of the regions set by the region setting unit has a different image quality; an image transformation unit which transforms the data of the image output from the shooting unit by performing a predetermined processing on the data of the image, a degree of the transformation being determined for each of the regions according to a level of the image quality of each of the regions encoded by the encoding unit; and a display unit which displays on a display device the data of the image transformed by the image transformation unit.

By this embodiment, before shooting or during shooting, a user can recognize on the display device in real time at what level of image quality a plurality of regions in an image is encoded.

Still another preferred embodiment according to the present invention relates an image display apparatus. This apparatus comprises: a means for displaying an image; a means for setting a region of interest for the image; a means for enlarging the region of interest; and a means for making the enlarged region of interest follow movement of an object in the region of interest. By this embodiment, since a region of interest is enlarged and displayed and furthermore the region of interest automatically moves following movement of an object in the region of interest, the region of interest can stand out in an easy way.

The region of interest may be manually set for the image. By this, a user can set a region of interest while viewing a displayed image.

The region of interest may be automatically set for the image by detecting the movement of the object in the image. By employing this structure, a region containing an object that has moved is automatically enlarged and displayed as a region of interest.

The apparatus may further comprise a means for making the region of interest and other region have different image qualities. By employing this structure, once a region of interest is decoded in a high quality, the region can be enlarged in the high quality and therefore an object of user interest can be made stand out more easily. Moreover, since the processing amount can be reduced when compared with the case of decoding the entire image in a high image quality, the speed of the process can be raised and the power consumption can be reduced.

The apparatus may further comprise a means for making the region of interest and other region have different resolutions. By employing this structure, once a region of interest is decoded in a high quality, even when the region is enlarged, the region is displayed in detail with a fine quality and therefore an object of user interest can be stand out more easily. Moreover, since the processing amount can be reduced when compared with the case of decoding the entire image in a high resolution, the speed of the process can be raised and the power consumption can be reduced.

The means for enlarging the region of interest may extract data corresponding to the region of interest from the image and perform an enlargement processing on the extracted data, and preserve the data obtained by the enlargement processing separately from data of the image, and wherein the means for displaying the image may read the data preserved separately and display an image based on the data preserved separately in the region of interest and a peripheral region thereof. By employing this structure, an image in which a region of interest is enlarged can be displayed in an easy way while the original image can be preserved. Therefore, the original image can be output to the outside and it is also possible to detect movement of an object in the region of interest using the original image.

The means for enlarging the region of interest may extract data corresponding to the region of interest from the image and perform an enlargement processing on the extracted data, and overwrite data corresponding to the region of interest and a peripheral region thereof by data obtained by the enlargement processing, and wherein the means for displaying the image may read the overwritten data and display an image based on the overwritten data. By this, an image in which a region of interest is enlarged can be displayed in an easy way and data corresponding to the enlarged region of interest does not need to be separately preserved. Therefore, a capacity of a memory necessary for enlarging the region of interest can be reduced.

It is to be noted that any arbitrary combination of the above-described structural components and expressions changed among a method, an apparatus, a system, a computer program, a recording medium and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 illustrates a structure of a digital camera according to the first embodiment of the present invention.

FIG. 2 illustrates an example of priority setting when a plurality of regions of interest are provided in an original image.

FIG. 3 shows a structure of an encoding unit according to the first embodiment.

FIGS. 4A to 4C illustrate masks for specifying wavelet transform coefficients corresponding to a region of interest in an original image.

FIGS. 5A to 5C illustrate how low-order bits of wavelet transform coefficients of an original image are zero-substituted.

FIG. 6 shows a structure of an image transformation unit according to the first embodiment.

FIG. 7A shows a structure of a filter unit according to the first embodiment, and FIG. 7B shows a table indicating a correspondence between an image quality level and filter coefficients.

FIG. 8 illustrates a structure of a digital camera according to the second embodiment of the present invention.

FIG. 9 is a flowchart showing a procedure of setting position, size and image quality for each ROI region while viewing a displayed image in a digital camera according to the second embodiment.

FIG. 10 illustrates a structure of a digital camera according to the third embodiment of the present invention.

FIG. 11 is a flowchart showing a procedure of setting position, size and image quality for each ROI region while viewing a displayed image in a digital camera according to the third embodiment.

FIG. 12A shows a structure of a image transformation unit according to the fourth embodiment, and FIG. 12B shows a table indicating a correspondence between an image quality level and a brightness conversion coefficient.

FIG. 13A shows a structure of a image transformation unit according to the fifth embodiment, and FIG. 13B shows a table indicating a correspondence between an image quality level and a color conversion coefficient.

FIG. 14 shows a structure of an image transformation unit according to the sixth embodiment.

FIG. 15 illustrates a structure of an image processing apparatus according to the seventh embodiment of the present invention.

FIG. 16A shows a ROI region set in an original image, and FIG. 16B shows an enlarged ROI region superimposed in the position of the ROI region set in the original image.

FIGS. 17A to 17C show a positional relation of an enlarged ROI region for a ROI region set in an original image.

FIG. 18 illustrates a structure of an image processing apparatus according to the eighth embodiment of the present invention.

FIG. 19A shows wavelet transform coefficients of a decoded image, FIG. 19B shows ROI transform coefficients and non-ROI transform coefficients, and FIG. 19C shows how two low bits of the non-ROI transform coefficients are substituted with zeros.

FIG. 20 illustrates a structure of an image processing apparatus according to the ninth embodiment of the present invention.

FIG. 21 illustrates a structure of an image processing apparatus according to the tenth embodiment of the present invention.

FIG. 22 illustrates a structure of a shooting apparatus according to the eleventh embodiment of the present invention.

FIG. 23A shows how a user specifies an object of interest in an image, FIG. 23B shows how a ROI region is set in an image, FIG. 23C shows a scene in which the object has moved out of the ROI region, and FIG. 23D shows how the ROI region follows movement of the object.

FIG. 24A shows how a user sets a ROI region in an image, FIG. 24B shows how a user specifies an object of interest in the ROI region, and FIG. 24C shows how the ROI region follows movement of the object.

FIG. 25A shows how a range in which a ROI region follows is set, FIG. 25B shows how a ROI region is set, and FIG. 25C shows a scene in which the object has moved out of a large frame.

### DETAILED DESCRIPTION OF THE INVENTION

The invention will now be described based on the preferred embodiments, which do not intend to limit the scope of the present invention, but exemplify the invention. All of the features and the combinations thereof described in the embodiments are not necessarily essential to the invention.

First, the present invention will now be described based on the first to sixth preferred embodiments. These embodiments relate to a digital camera.

### First Embodiment

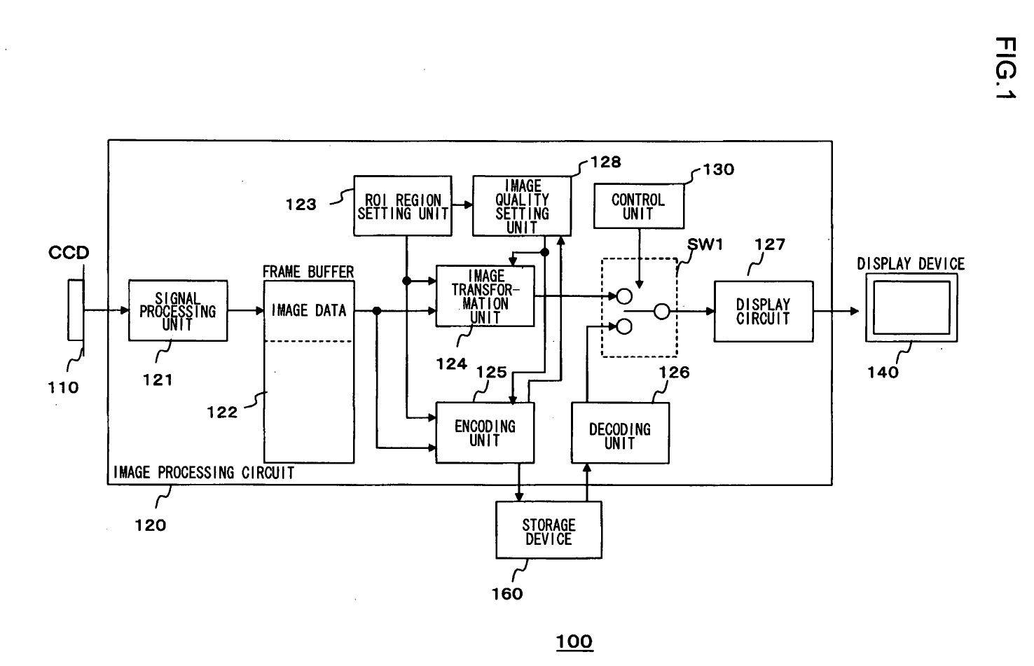

FIG. 1 illustrates a structure of a digital camera 100 according to the first embodiment of the present invention. In terms of hardware, this structure of the digital camera 100 can be realized by a CPU, a memory and other LSIs of an arbitrary computer. In terms of software, it can be realized by memory-loaded programs which have coding functions or the like, but drawn and described herein are function blocks that are realized in cooperation with those. Thus, it is understood by those skilled in the art that these function blocks can be realized in a variety of forms such as by hardware only, software only or the combination thereof.

The digital camera 100 includes a CCD 110 that takes in an image, an image processing circuit 120 that performs a prescribed process on the image taken by the CCD 110 and thereby generates coded image data and image data to be displayed, a storage device 160 that records the coded image data, and a display device 140 that displays the image data to be displayed.

The storage device 160 can be realized by a semiconductor memory or a hard disk built in the digital camera 100. Moreover, the storage device 160 may be composed of a detachable recording medium, a slot in which the recording medium can be inserted, and a circuit that controls an access to the recording medium. The detachable recording medium can be, for instance, a semiconductor memory, a hard disk, an optical disk, a magneto optical disk, or the like.

The display device 140 is composed by a liquid crystal display provided in the digital camera 100. Moreover, the display device 140 may be provided as an external monitor connected to the digital camera 100 via a cable.

The image processing circuit 120 includes a signal processing unit 121, a frame buffer 122, a ROI region setting unit 123, an image transformation unit 124, an encoding unit 125, a decoding unit 126, a switch SW1, a display circuit 127, an image quality setting unit 128, and a control unit 130.

The signal processing unit 121 takes an image signal out of the signal output from the CCD 110, and converts the image signal into a digital signal, and then performs correction such as pixel defect correction, white balance correction, and gamma correction. The frame buffer 122 is composed by a large-capacity semiconductor memory such as SDRAM, and records the image data corrected by the signal processing unit 121. The frame buffer 122 can store the image data for one frame or a couple of frames.

The ROI region setting unit 123 selects a region of interest in an original image, and supplies ROI position information indicative of the position of the region of interest to the image transformation unit 124 and the encoding unit 125. If the region of interest is selected as the form of a rectangle, the ROI position information is given by coordinate values of a pixel at the upper left corner of the rectangular area and the number of pixels in the vertical and horizontal directions of the rectangular area.

The region of interest may be selected in such a manner that a user specifies a specific region in the original image, or a predetermined region such as a central region in the original image may be selected. It may also be selected by an automatic extraction of an important region where there may be a human figure or text characters. As a method for the automatic extraction, there is, for instance, a method for separating the original image into some objects and the background, extracting the characteristic of each object, and judging whether there might appear any human figure or any text characters in the object. Alternatively, the original image may be divided into blocks, and a motion vector may be obtained for every block. If the motion vector for a certain block is different from the motion vectors for the other blocks, the certain block may be automatically extracted as a region of interest.

The ROI region setting unit 123 may select a plurality of regions of interest in the original image, and supply the ROI position information indicative of the positions of the respective regions of interest to the image transformation unit 124 and the encoding unit 125. The plurality of the regions of interest may have overlaps with each other, and the regions of interest may contain some regions of non-interest therein.

The ROI region setting unit 123 sets respective degrees of priority of image quality for a plurality of regions, and supplies the priority information to the image quality setting unit 128. For example, when the central part of an image and the periphery thereof are selected as a plurality of regions of interest and the rest of the image surrounding them as a region of non-interest, the central part of the image is set for a high degree of priority for a high image-quality reproduction and the periphery thereof is set for a lower degree of priority for a standard image-quality reproduction. As another example, when a region with text characters and a region with a human face are selected as a plurality of regions of interest, the region with text characters is set for the highest degree of priority for the highest image quality and the region with a human face set for a next degree of priority for a high image quality, while the rest of the image is set as a region of non-interest for a standard image quality. Alternatively, in order to protect the person's privacy, the region with a human face may also be set for a low degree of priority for a low image quality or as a region of non-interest.

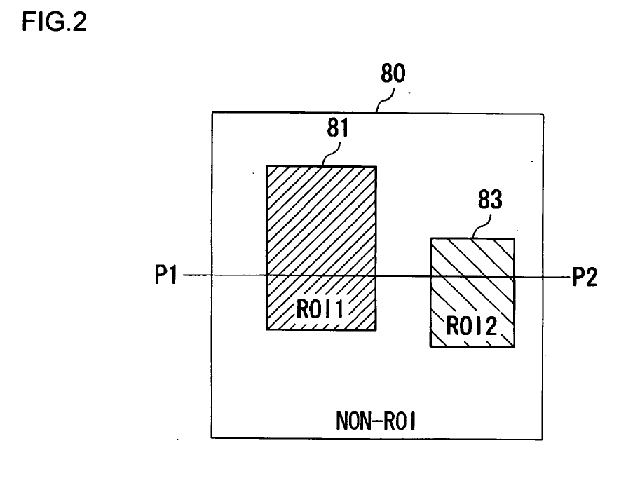

FIG. 2 illustrates an example of priority setting when a plurality of regions of interest are provided in the original image 80. When two regions of interest 81 and 83 are set in the original image 80 as shown in the figure, the ROI region setting unit 123 sets a priority order in a manner such that the degree of priority descends, for instance, in the order of the first region of interest 81 (ROIL hereafter), the second region of interest 83 (ROI2 hereafter), and the remaining region of non-interest (non-ROI hereafter).

While the priority of the image quality set by the ROI region setting unit 123 represents a relative relation between the image qualities of the respective regions, the image quality setting unit 128 determines an absolute level of the image quality. The image quality setting unit 128 determines the level of the image quality of the respective regions according to the priority of the image quality of the respective regions obtained from the ROI region setting unit 123, and provides this information on the image quality level to the image transformation unit 124 and the encoding unit 125. Moreover, the image quality level of the respective regions can be adjusted according to the amount of the encoded data obtained from the encoding unit 125. More specifically, when the amount of the encoded data becomes larger than a desired value, the amount of the encoded data is decreased by lowering the image quality level of the entire image or lowering the image quality level of a low-priority region. On the other hand, when the amount of the encoded data is smaller than a desired value, the amount of the encoded data is increased by raising the image quality level of the entire image or raising the image quality level of a high-priority region. It is noted that the image quality level is herein adjusted according to the priority of the image quality so that the relative relation between the priorities of the respective regions may be maintained.

The encoding unit 125 compression-encodes the image data (hereafter referred to as the original image) input from the frame buffer 122 according to JPEG2000 (ISO/IEC 15444-1: 2001), an image compression technique that has been standardized by ISO/ITU-T, for instance. The image input to the encoding unit 125 is a frame of a moving image. The encoding unit 125 can continuously encode each frame of the moving image according to JPEG2000, and then generate a coded stream of the moving image according to the format standardized by Motion JPEG2000 (ISO/IEC 15444-3:2002).

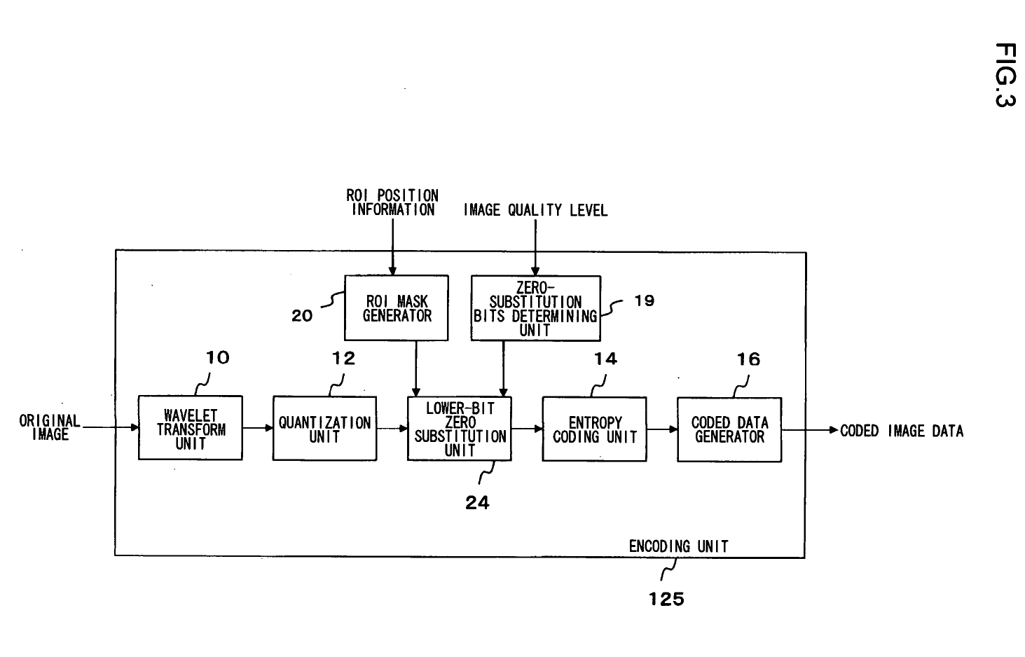

FIG. 3 shows a structure of the encoding unit 125. A wavelet transform unit 10 divides the original image into sub-bands, computes wavelet transform coefficients of each sub-band image and then generates hierarchized wavelet coefficients.

The wavelet transform unit 10 applies a low-pass filter and a high-pass filter in the respective x and y directions of the original image, and divides the image into four frequency sub-bands so as to carry out a wavelet transform. These sub-bands are an LL sub-band which has low-frequency components in both x and y directions, an HL sub-band and an LH sub-band which have a low-frequency component in one of the x and y directions and a high-frequency component in the other, and an HH sub-band which has high-frequency component in both x and y directions. The number of pixels in the vertical and horizontal directions of each sub-band is ½ of that of the image before the processing, and one time of filtering produces sub-band images whose resolution, or image size, is ¼ of the image.

The wavelet transform unit 10 performs another filtering processing on the image of the LL sub-band among the thus obtained sub-bands and divides it into another four sub-bands LL, HL, LH and HH so as to perform the wavelet transform. The wavelet transform unit 10 performs this filtering a predetermined number of times, hierarchizes the original image into sub-band images and then outputs wavelet transform coefficients for each of the sub-bands. A quantization unit 12 quantizes, with a predetermined quantizing width, the wavelet transform coefficients output from the wavelet transform unit 10.

A ROI mask generator 20 generates ROI masks for specifying the wavelet transform coefficients corresponding to the region of interest, that is, ROI transform coefficients, by referring to the ROI position information output from the ROI region setting unit 123.

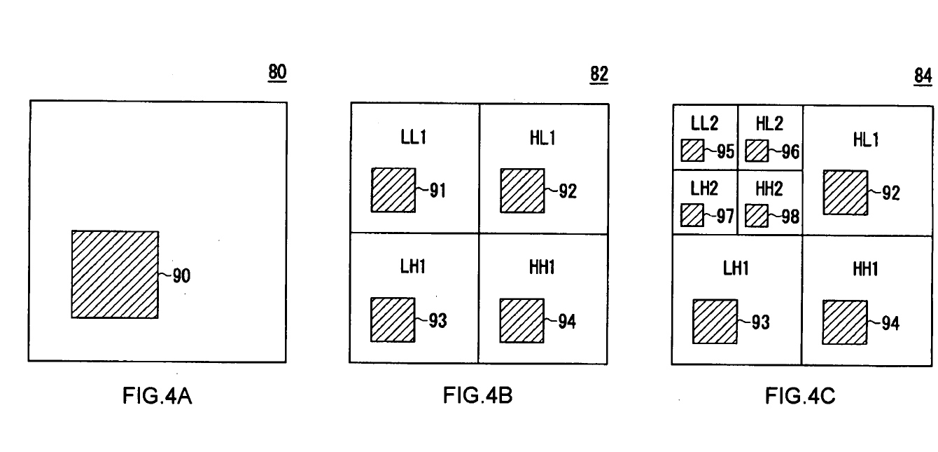

FIGS. 4A to 4C illustrate the ROI masks generated by the ROI mask generator 20. As shown in FIG. 4A, suppose that a region of interest 90 is selected on the original image 80 by the ROI region setting unit 123. Then, the ROI mask generator 20 specifies, in each sub-band, wavelet transform coefficients necessary for restoring the selected region of interest 90 on the original image 80.

FIG. 4B shows a first-hierarchy transform image 82 obtained by performing one-time wavelet transform on the original image 80. The transform image 82 in the first hierarchy is composed of four first-level sub-bands which are represented here by LL1, HL1, LH1 and HH1. In each of the first-level sub-bands of LL1, HL1, LH1 and HH1, the ROI mask generator 20 specifies wavelet transform coefficients on the first-hierarchy transform image 82, namely, ROI transform coefficients 91 to 94 necessary for restoring the region of interest 90 in the original image 80.

FIG. 4C shows a second-hierarchy transform image 84 obtained by performing another wavelet transform on the sub-band LL1 which is the lowest-frequency component of the transform image 82 shown in FIG. 4B. Referring to FIG. 4C, the second-hierarchy transform image 84 contains four second-level sub-bands which are composed of LL2, HL2, LH2 and HH2, in addition to three first-level sub-bands HL1, LH1 and HH1. In each of the second-level sub-bands of LL2, HL2, LH2 and HH2, the ROI mask generator 20 specifies wavelet transform coefficients on the second-hierarchy transform image 84, namely, ROI transform coefficients 95 to 98 necessary for restoring the ROI transform coefficient 91 in the sub-band LL1 of the first-hierarchy transform image 82.

In the similar manner, by specifying recursively the ROI transform coefficients that correspond to the region of interest 90 at each hierarchy for a certain number of times corresponding to the number of wavelet transforms done, all ROI transform coefficients necessary for restoring the region of interest 90 can be specified in the final-hierarchy transform image. The ROI mask generator 20 generates a ROI mask for specifying the position of this finally specified ROI transform coefficient in the last-hierarchy transform image. For example, when the wavelet transform is carried out two times only, generated are ROI masks which can specify the position of seven ROI transform coefficients 92 to 98 which are represented by areas shaded by oblique lines in FIG. 4C.

Based on the level of the image quality set by the image quality setting unit 128, a zero-substitution bits determining unit 19 determines the number of low-order bits 50 to be zero-substituted in the bit string of the non-ROI transform coefficients, which are the wavelet transform coefficients corresponding to the region of non-interest, and the number of low-order bits Si (i=1, . . . , N; N being the number of regions of interest) to be zero-substituted in the bit string of the ROI transform coefficients, which are the wavelet transform coefficients corresponding to each of the plurality of regions of interest.

In the example of FIG. 2, if, for instance, the wavelet transform coefficients of the original image is made up of 7 bit-planes, then the zero-substitution bits determining unit 19 will set 0 for the number of zero-substitution bits S1 for the first priority region of interest ROI1, 2 for the number of zero-substitution bits S2 for the second priority region of interest ROI2, and 4 for the number of zero-substitution bits 50 for the region of non-interest. In other words, the lower the degree of priority, the larger the number of zero-substitution bits will be.

A lower-bit zero substitution unit 24 refers to the ROI masks for the respective regions of interest generated by the ROI mask generator 20 and zero-substitutes 50 bits only counted from the lowest bit in the bit string of the non-ROI transform coefficients not masked by the ROI masks and also zero-substitutes Si bits only counted from the lowest bit in the bit string of the ROI transform coefficients masked by the ROI masks.

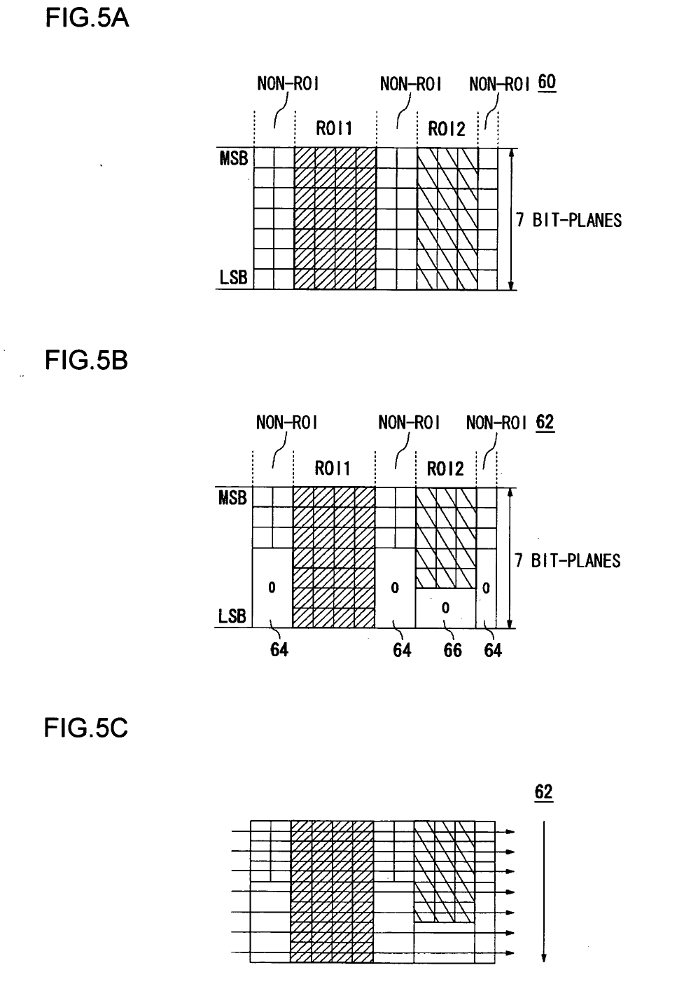

FIGS. 5A to 5C illustrate how the low-order bits of the wavelet transform coefficients 60 of an original image are zero-substituted by the lower-bit zero substitution unit 24. FIG. 5A shows the wavelet transform coefficients 60 after quantization by the quantization unit 12. They include 7 bit-planes, and the ROI transform coefficients are shaded with oblique lines. FIG. 5A represents the bit string of wavelet transform coefficients corresponding to the pixels on line P1-P2 in the example of the original image 80 containing two regions of interest ROIL and ROI2 shown in FIG. 2.

As is shown in FIG. 5B, the lower-bit zero substitution unit 24 substitutes the S0 bits on the LSB side of the non-ROI transform coefficients not masked by ROI masks. In this example, 50=4, and as reference numeral 64 indicates in FIG. 5B, the 4 bits on the LSB side of the non-ROI transform coefficients are substituted with zeros. Furthermore, the lower-bit zero substitution unit 24 substitutes the Si bits on the LSB side of the ROI transform coefficients masked by the ROI masks with zeros. In this example, where two regions of interest, namely, ROIL and ROI2, are set, their respective numbers of zero-substituted bits S1 and S2 are 0 and 2, and as reference numeral 66 indicates in FIG. 5B, the 2 bits on the LSB side of the ROI transform coefficients corresponding to ROI2 are substituted with zeros. In this manner, wavelet transform coefficients 62 which have been zero-substituted by the lower-bit zero substitution 24 are obtained.

An entropy coding unit 14 shown in FIG. 3 entropy-codes the wavelet transform coefficients 62 containing the ROI transform coefficients and the zero-substituted non-ROI transform coefficients by scanning the bit-planes in order from MSB as indicated by the arrows in FIG. 5C.

A coded data generator 16 processes the entropy-coded data into a stream together with such coding parameters as quantizing width and outputs it as a coded image. The coded data generator 16 accumulates the coding amount of the stream data and gives the coding amount to the image quality setting unit 128.

The coded image data is recorded in a storage device 160. This coded image, which contains a plurality of regions with different image qualities at reproduction, is read from the storage device 160 and decoded by a decoding unit 126, and then reproduced on the screen of the display apparatus 140.

An image transformation unit 124 of FIG. 1, which includes a filter that removes high-frequency components of the image, performs a filtering process in real time on the image data (original image) input from the frame buffer 122 so that the image quality of each region, which has been set by the ROI region setting unit 123 and the image quality setting unit 128, can differ. The image transformation unit 124 generates a through image (an image neither compressed nor expanded that is taken by the CCD110) so that the image taken into the CCD 110 can be displayed on the display apparatus 140 when the camera 100 is in a shooting mode. The image transformation unit 124 operates independently of the encoding unit 125. In the shooting mode, the user confirms the through image displayed on the display apparatus 140, decides the size of an object and a shooting condition and then pushes the shutter button. And thereby, the image is compressed in the encoding unit 125 and recorded in the storage device 160. Moreover, in taking a moving picture, a through image during the shooting is displayed on the display apparatus 140.

In the shooting mode, it might be possible to decode again the image data in which a plurality of regions are encoded in different image qualities and display the decoded image, so that a user could confirm the image quality of the respective regions. However, the processing time by the encoding and decoding becomes large and real timeliness will be lost. Moreover, the encoding and decoding process becomes very wasteful if it is done only for confirming the image quality of the respective regions before taking a picture. Instead, according to the present embodiment, the image transformation unit 124 generates in real time the image with the respective regions having different image qualities and displays this image on the display apparatus. Thereby, a user can immediately confirm the image quality level of the respective regions.

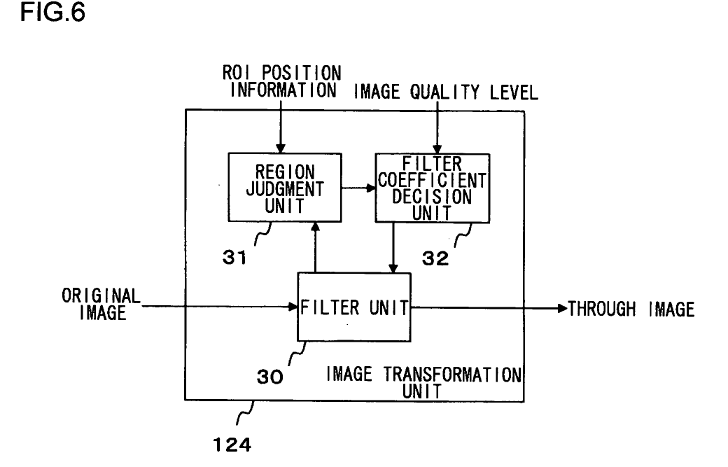

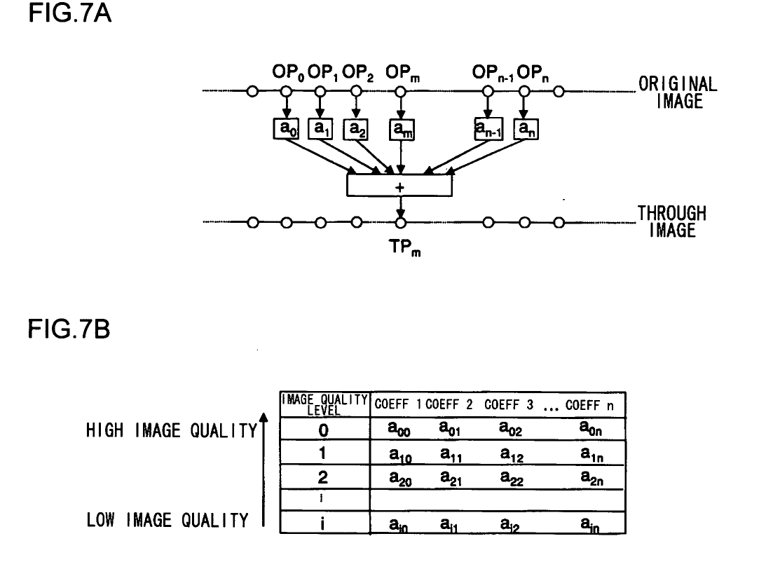

FIG. 6 shows a structure of the image transformation unit 124. The image transformation unit 124 includes a filter unit 30, a region judgment unit 31, and a filter coefficient decision unit 32. The filter unit 30 performs a filtering process on each pixel of the input original image and generates a through image. FIG. 7A shows an example of the filter unit 30. This filter obtains a pixel TPm of the through image from the n pixels of OP1 to OPn that align in the horizontal direction of the original image. More specifically, it is a low-pass filter that calculates the pixel TPm of the through image by multiplying the each pixel OP1-OPn of the original image by the filter coefficient a1-an respectively, and then adding those results of the multiplication.

The filter coefficients used by the filter unit 30 is decided by the following method. The filter unit 30 sends the coordinate position of the pixel to be filtered to the region judgment unit 31. When the region judgment unit 31 receives the coordinate position information of the pixel to be filtered from the filter unit 30, the region judgment unit 31 compares the coordinate position information with the ROI position information output from the ROI region setting unit 123. The region judgment unit 31 judges whether the pixel to be filtered is located in the region of interest or not. If a plurality of the regions of interest exist, the region judgment unit 131 judges which region of interest the pixel is located in. The region judgment unit 31 outputs the judgment result to the filter coefficient decision unit 32.

The filter coefficient decision unit 32 specifies the image quality level of the region to which the pixel to be filtered belongs, by referring to the judgment result of the region judgment unit 31 and the image quality level of each region output from the image quality setting unit 128, and outputs the filter coefficient corresponding to the image quality level to the filter unit 30. The correspondence between the image quality level and the filter coefficient is stored as a table in the filter coefficient decision unit 32. For instance, there is a table shown in FIG. 7B in the filter coefficient decision unit 32 when the filter unit 30 is configured as shown in FIG. 7A. In this table, the filter coefficients a1-an are provided for each of the image quality level 0 to i. The filter coefficient decision unit 32 outputs to the filter unit 30 the filter coefficients a1-an corresponding to the specified image quality of the region which the pixel to be filtered belongs to. The filter coefficients need not be prepared for all the image quality levels in the table, and the filter coefficients may be prepared only for a typical image quality level. In this case, if the image quality level that does not exist in the table is specified, the filter coefficients near the specified image quality level are output to the filter unit 30.

In FIG. 7, an example is given in which the low-pass filter is applied to pixels in the horizontal direction, however, a low-pass filter of a similar structure may be applied to pixels in the vertical direction. Moreover, the low-pass filter may be applied for both the horizontal and vertical directions. In this case, the number of pixels n may be different in the horizontal direction and the vertical direction. The correspondence table of the resolution level and the filter coefficients may be provided separately for the low-pass filter in the horizontal direction and the low-pass filter in the vertical direction. Alternatively, the same correspondence table may be used for deciding the filter coefficients for each direction.

Moreover, the process for substituting the low-order bits with zeros for each pixel data of the original image may be performed before the low-pass filter is applied. As a result, an image which is close to an image when the coded image data is decoded can be generated by the image transformation unit 124. The number of bits to be substituted with zeros is stored together with the filter coefficients in the table in the filter coefficient decision unit 32.

Thus, the image transformation unit 124 can generate the image in which each region set by the ROI region setting unit 123 has a different image quality.

The display circuit 127 of FIG. 1 outputs the image to be displayed on the display device 140 in accordance with the specification of the display device 140. For instance, the display circuit 127, which has a function of performing a number-of-pixels conversion process, expands or reduces an image to be displayed in accordance with the number of pixels of the display device 140. Then, the display circuit 127 outputs each pixel data of the expanded or reduced image to the display device 140 along with the driving signal for the display device 140. The display device 140 displays the image on the display based on the driving signal and the pixel data given from the display circuit 127. This display circuit 127 and the display apparatus 140 are an example of a display unit of the present invention.

The digital camera 100 of FIG. 1 includes the switch SW1 in front of the display circuit 127. The through image generated by the image transformation unit 124 and the decoded image generated by the decoding unit 126 are input to the switch SW1, and either one of the images is output to the display circuit 127 according to the connection status in the switch SW1.

The connection status in the switch SW1 is controlled by the control unit 130. For instance, when the digital camera 100 is in a shooting mode and more specifically when the encoding unit 125 performs encoding, the switch SW1 is connected to the through image generated by the image transformation unit 124, and thereby the through image is output to the display circuit 127. When the digital camera 100 is in a replay mode and more specifically when the decoding unit 126 decodes the coded image data, the switch SW1 is connected to the decoded image generated by the decoding unit 126, and thereby the decoded image is output to the display circuit 127.

According to the above-mentioned configuration, when the encoding unit 125 performs encoding, the image transformation unit 124 can generate in real time the image in which the each region set by the ROI region setting unit 123 has a different image quality, and display the image on the display device 140. Therefore, there is an advantage that a user can recognize how the coded image with a plurality of regions of different image qualities is decoded, and especially a user can recognize in real time at what image quality level each region will be encoded, while viewing the image displayed on the display apparatus.

### Second Embodiment

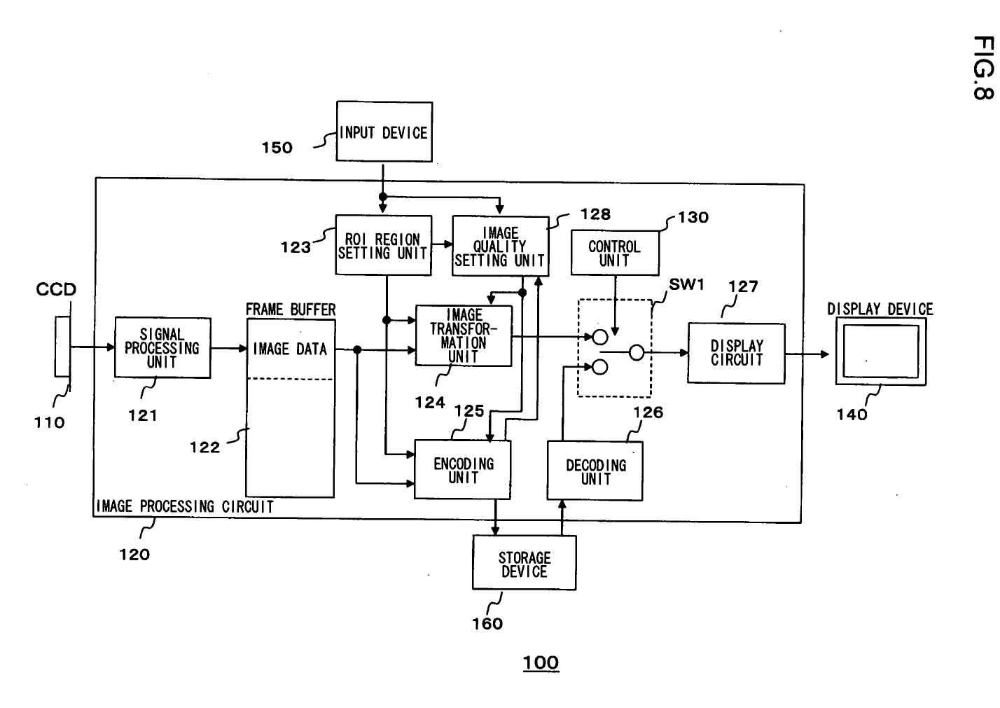

FIG. 8 illustrates a structure of a digital camera 100 according to the second embodiment of the present invention. Since this structure is similar to one of the digital camera 100 shown in FIG. 1, the description is only given for points characteristic of this embodiment and the other explanations will be omitted.

The digital camera 100 of FIG. 8 comprises an input device 150. The input device 150 allows a user to input a position, size and priority of image quality of a ROI region for the digital camera 100 in the shooting mode. The ROI region setting unit 123 sets a ROI region according to the position and the size of the ROI region input to the input device 150, and sends the position information to the image transformation unit 124 and the encoding unit 125. When a plurality of ROI regions are input through the input device 150, the position information of each region is sent to the image transformation unit 124 and the encoding unit 125. Moreover, the ROI region setting unit 123 sets the priority of each region according to the priority of the image quality of each ROI region input to the input device 150, and sends the priority information to the image quality setting unit 128.

Moreover, the input device 150 allows a user to confirm the position, size and image quality level of each region displayed on the display device 140, and adjust them respectively. In this case, a position, size and priority of the image quality of each region newly input to the input device 150 becomes effective in the ROI region setting unit. Moreover, the input device 150 can adjust the image quality level of each region without changing the priority of the image quality. This image quality level becomes effective directly in the image quality setting unit 128.

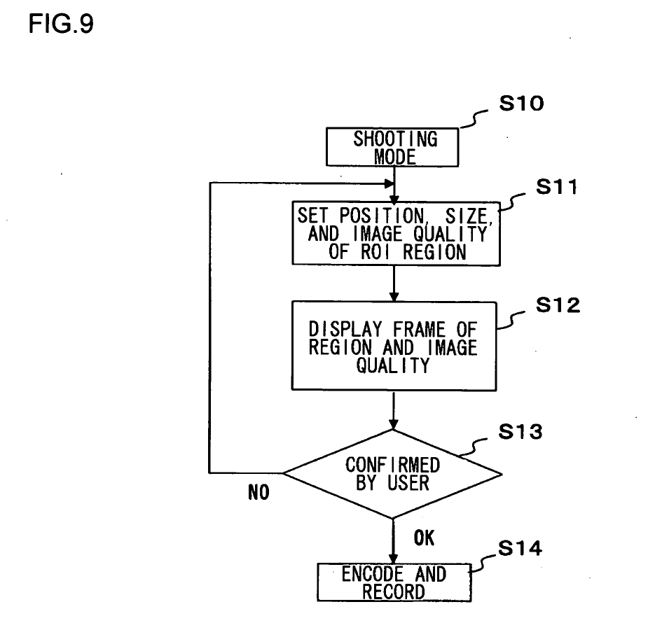

FIG. 9 is a flowchart showing a procedure of the digital camera 100 of FIG. 8 setting and adjusting the position, size and image quality of the ROI region. When the digital camera 100 is set to the shooting mode (S10), a user can set a position, size and priority of image quality for each ROI region by using the input device (S11). Once these parameters are set, the image with respective regions having the position, size and image quality level appropriately decided by the image quality setting unit 128 is displayed in real time on the display device 140 (S12). The user confirms the image displayed on the display device 140 (S13) and if the user wants to change the position, size, priority of the image quality or image quality level of the ROI region, the procedure returns to the step S11 and the user adjusts them. If the user is satisfied, the user pushes the shutter button provided in the input device, and thereby the image is encoded by the encoding unit 125 according to the conditions set for the ROI region and recorded in the storage device 160 (S14). If the user does not especially set any ROI region at the step S11, the image is displayed on the display device 140 in such a manner that the entire image has a uniform image quality, and the image is encoded in the encoding unit 125 in such a manner that the entire image has a uniform image quality.

According to the above-mentioned configuration, by viewing the image displayed in real time on the display device 140, a user can confirm and immediately adjust the position, size and image quality level of the region with different image quality obtained after encoding. Therefore the convenience for users can improves.

### Third Embodiment

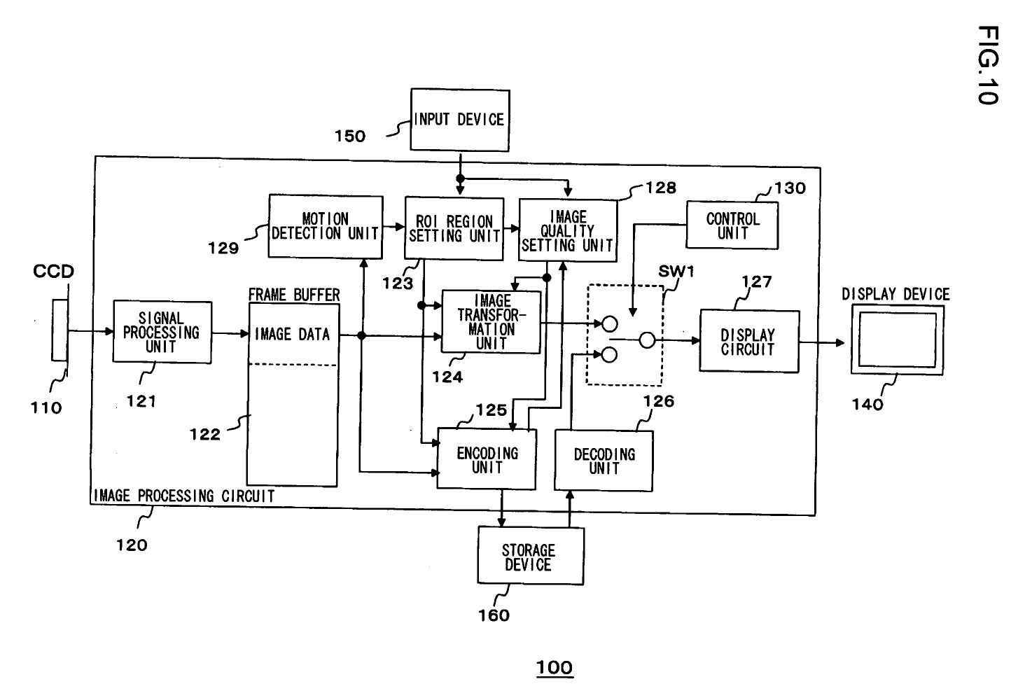

FIG. 10 illustrates a structure of the digital camera 100 according to the third embodiment of the present invention. Since this structure is similar to one of the digital camera 100 shown in FIG. 1, the description is only given for aspects characteristic of this embodiment and the other explanations will be omitted.

The digital camera 100 of FIG. 10 includes a motion detection unit 129. By this, a ROI region set once is pursued according to movement of an object during taking a motion picture, and then the ROI region continues to be automatically set. The motion detection unit 129 detects a position of a specified object and outputs the detected position to the ROI region setting unit 123. The user may specify the object or the motion detection unit 129 may recognize the object automatically in the ROI region specified by the user. Moreover, the motion detection unit 129 may automatically recognize the object in the entire image. A plurality of the objects may be specified.

In the case of a motion image, the position of the object can be represented by a motion vector. Hereafter, some concrete examples of a motion vector detection method are described. As one method, the motion detection unit 129, which includes a memory such as SRAM or SDRAM, preserves the image of the object specified in the frame at specifying the object into the memory as a reference image. As a reference image, a block of a predetermined size containing a specified position may be preserved. The motion detection unit 129 detects a motion vector by comparing the reference image with the current frame image. The calculation of the motion vector can be done by specifying an outline element of the object by using some high-frequency components of the wavelet transform coefficients. For this calculation, MSB (Most Significant Bit) bit-plane of the wavelet transform coefficients after the quantization or a plurality of bit-planes taken from the MSB side may be utilized.

As the second method, the motion detection unit 129 compares the current frame with a previous frame, for instance, an immediately preceding frame, and detects the motion vector of the object. As the third method, the motion detection unit 129 compares the wavelet transform coefficients after wavelet transform instead of the frame image, and detects the motion vector. As the wavelet transform coefficients, any one of LL sub-band, HL sub-band, LH sub-band and HH sub-band may be used. In addition, the image to be compared with the current frame may be a reference image registered at the time of specifying it, or may be a reference image registered for a previous frame, for instance, an immediately preceding frame.

As the fourth method, the motion detection unit 129 detects the motion vector of the object by using a plurality of sets of the wavelet transform coefficients. For instance, the motion vectors are detected for each HL sub-band, LH sub-band, and HH sub-band, and the average of these three motion vectors may be calculated, and the one that is closest to a motion vector of a previous frame may be selected from among these motion vector. By this, the motion detection accuracy of the object can be improved.

In FIG. 10, the input to the motion detection unit 129 is an image stored in the frame buffer 122, however, the motion detection unit 129 may calculate the motion vector by using the wavelet transform coefficients as described above. In this case, the output from the wavelet transform unit 10 in the encoding unit 125 shown in FIG. 3 may be used as an input to the motion detection unit 129.

Moreover, a user may specify a range, where such a motion vector is detected in the image, for the motion detection unit 129 beforehand. For instance, when this image coding apparatus is applied to a surveillance camera at a store such as a convenience store, a process can be done in such a manner that an object such as a person who entered a constant range from the cash register will be given attention and the movement of the object that has gone out of the range will not be given attention any longer.

The ROI region setting unit 123 obtains position information such as the motion vector of the object from the motion detection unit 129, and moves the ROI region in accordance with the position information. The ROI region setting unit 123 calculates the amount of the movement from the initial position of the ROI region or the amount of movement from an immediately preceding frame according to the detection method by the motion detection unit 129, and determines the position of the ROI region in the current frame.

The image transformation unit 124 performs the image transformation according to the position information of the ROI region given from the ROI region setting unit 123 and the image quality level given from the image quality setting unit 128 so that the image quality of each region can differ. Similarly, the encoding unit 125 encodes the image according to the position information of the ROI region given from the ROI region setting unit 123 and the image quality level given from the image quality setting unit 128 so that the image quality of each region can differ. Then, when the digital camera 100 is in a shooting mode, and more specifically when the encoding unit 125 performs encoding, the through image generated by the image transformation unit 124 is output in real time to the display circuit 127.

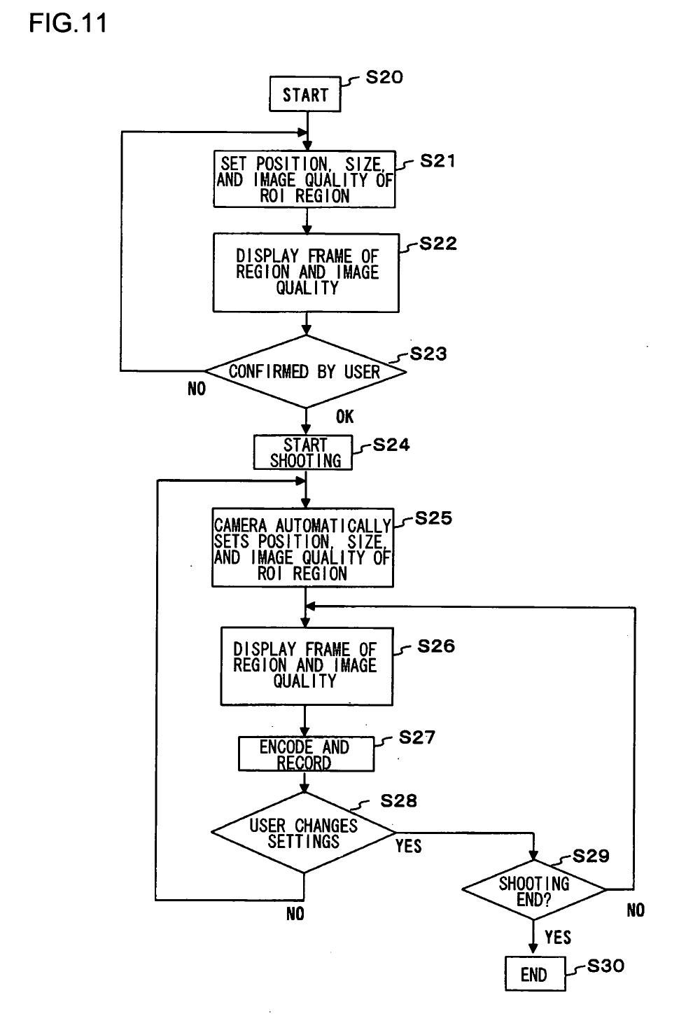

FIG. 11 is a flowchart showing a procedure of the digital camera 100 of FIG. 10 setting and adjusting the position, size and image quality of the ROI region. When the digital camera 100 is set to a shooting mode (S20), a user inputs a position, size and priority of image quality of a ROI region via the input device 150 and sets them as initial values for the ROI region setting unit 123 (S21). When the user specifies an object or the motion detection unit 129 recognizes it automatically, the ROI region setting unit 123 may automatically set as the ROI region a predetermined range which contains the object therein.

The shape of the ROI region may be a rectangle, a circle, or any other complicated shapes. The shape of the ROI region should be fixed, in principle, however, the shape of the region may be changeable depending on whether the region is the central part of the image or the periphery thereof, or the shape may be dynamically changeable by a user operation. Moreover, a plurality of the ROI regions may be set.

Once the position, size and priority of the image quality of the ROI region are set, the image in which each region has the position, size and image quality level determined appropriately by the image quality setting unit 128 is displayed in real time on the display device 140 (S22). The user confirms the image displayed on the display device 140 (S23), and if the user wants to change the position, size and priority of the image quality of the ROI region, and furthermore change the image quality level by a method similar to one in the second embodiment, the procedure returns to the step S21 and the user adjusts them. If the user is satisfied, the user pushes the shutter button provided in the input device and thereby starts to shoot a motion image (S24).

When the shooting of the motion image starts, the ROI region is pursued by the motion detection unit 129 and the position and the size of the ROI region are set automatically by the ROI region setting unit 123. Moreover, the image quality level of each region is automatically set by the image quality setting unit 128, based on the amount of the coded data output from the encoding unit 125 by the method described in the first embodiment (S25). Then, a through image in which each of these regions has the defined position, size and image quality level is displayed (S26), and also the image is encoded by the encoding unit 125 in such a manner that each region has the defined position, size and image quality level and the coded image is recorded in the storage device 160 (S27). While taking the motion picture, the user can confirm the image displayed at the step S26, and can change the settings of the position, size, priority of the image quality, and the image quality level of the ROI region (S28). At the step S28, an instruction for ending shooting is received. The end of shooting can be recognized by the user's pushing the shutter button again.

The procedure returns to the step S25 if the user does not change any settings at the step S28, and the digital camera 100 automatically sets the position, size and image quality level of the ROI region. If the user changes any settings at the step S28, it is judged whether it is an instruction for ending shooting (S29). If it is an instruction for ending shooting, the shooting is terminated (S30). If it is not an instruction for ending shooting, the position, size, priority of the image quality level, or the image quality level of the ROI region changed by the user becomes effective in the ROI region setting unit 123 or the image quality setting unit 128, and the procedure returns to the step S26.

By the above-mentioned configuration, there are the following advantages.

(1) In the case where encoding is performed continuously as it is when a motion image is being shot, the image transformation unit 124 can generate in real time a through image in which each region has the specified position, size and image quality level and the display device 140 can display the image. Therefore, a user can immediately recognize the position, size and image quality level of each region of the encoded motion image in any time. When the ROI region is pursued and the position, size and image quality level is automatically set, the results of the automatic setting can be immediately recognized. In such a case, the embodiment is especially effective.

(2) In the case where encoding is performed continuously as it is when a motion image is being shot, a user can confirm, for a region with a different image quality obtained by the encoding, its position, size and image quality level and then immediately change the settings. Furthermore, since any change in the settings becomes effective in the through image in real time, the convenience of the user can be improved.

### Fourth Embodiment

A digital camera 100 according to the fourth embodiment has the same structure as that of FIG. 1, however, the function of the image transformation unit 124 is different. The image transformation unit 124 in this embodiment has a function of performing a process for converting brightness data in the image for each pixel. The image transformation unit 124 performs brightness conversion on the image data (original image) input from the frame buffer 122 so that the image quality of each region set by the ROI region setting unit 123 can differ.

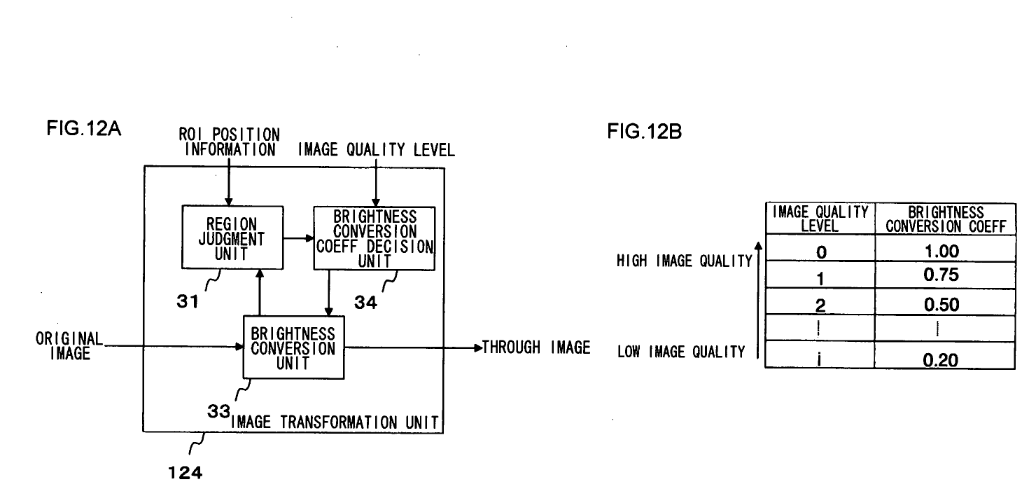

FIG. 12A shows a structure of the image transformation unit 124. The image transformation unit 124 includes a brightness conversion unit 33, a region judgment unit 31, and a brightness conversion coefficient decision unit 34. The brightness conversion unit 33 converts brightness for each pixel of the input original image, and thereby generates a through image. The brightness conversion is done by the following expression.
TPY(x,y)=aY(x,y) OPY(x,y) (1)

Here, OPY represents brightness data of the original image, TPY represents brightness data of a through image, and (x,y) represents the pixel location in each image. aY(x,y) is a brightness conversion coefficient in the pixel (x,y) of the original image.

This brightness conversion coefficient aY(x,y) is determined by the following method. The brightness conversion unit 33 sends the coordinate position (x,y) of the pixel subject to the brightness conversion to the region judgment unit 31. When receiving the coordinate position information of the pixel from the brightness conversion unit 33, the region judgment unit 31 compares it with the ROI position information output from the ROI region setting unit 123 and judges whether the pixel subject to the brightness conversion is located in the region of interest or not. If a plurality of the regions of interest exist, the region judgment unit 31 judges which region of interest the pixel is located in. The region judgment unit 31 outputs the judgment result to the brightness conversion coefficient decision unit 34.

The brightness conversion coefficient decision unit 34 specifies an image quality level of the region which the pixel subject to the brightness conversion belongs to, according to the result of the region judgment unit 31 and the image quality level of each region output from the image quality setting unit 128, and outputs the brightness conversion coefficient aY(x,y) corresponding to the specified image quality level to the brightness conversion unit 33. The correspondence between the image quality level and the brightness conversion coefficient is stored as a table in the brightness conversion coefficient decision unit 34. FIG. 12B is an example of the table that stores the correspondence between the image quality level and the brightness conversion coefficient. In this table, the brightness conversion coefficients are defined for the image quality levels 0 to i. A value close to 1 is stored as a brightness conversion coefficient in the table at an image quality level corresponding to a higher image quality, while a value close to 0 is stored as a brightness conversion coefficient at an image quality level corresponding to a lower image quality. By this, the brightness level of a region of a high image quality can be kept at a level close to the original image and the brightness level of a region of a low image quality is kept low. Therefore, the through image output by the image transformation unit 124 is an image in which the region of a lower image quality level becomes darker.

The brightness conversion coefficients need not be prepared for all the image quality levels in the table, and the brightness conversion coefficients may be prepared only for a typical image quality level. In this case, if the image quality level that does not exist in the table is specified, a brightness conversion coefficient near the specified image quality level is output to the brightness conversion unit 33.

According to the above-mentioned configuration, when the encoding unit 125 performs encoding, the image transformation unit 124, by a simple structure, can generate an image in real time in which the image quality level of each region set by the ROI region setting unit 123 is represented by the difference in the brightness level, and display this image on the display device 140. Therefore, there is an advantage that the user can recognize in real time at what image quality level each region will be encoded in the coded image in which a plurality of regions have different image qualities, while viewing the image displayed on the display apparatus. Furthermore, since human eyes are sensitive to change in brightness, if an image in which the brightness of each region differs is displayed on the display apparatus, the image quality level of each region when it is encoded can be easily recognized.

### Fifth Embodiment

A digital camera 100 according to the fifth embodiment has the same structure as that of FIG. 1, however, the function of the image transformation unit 124 is different. The image transformation unit 124 in this embodiment has a function of performing a process for converting color difference data of the image for each pixel, and performs the color transformation on the image data (original image) input from the frame buffer 122 so that the image quality of each region set by the ROI region setting unit 123 can differ.

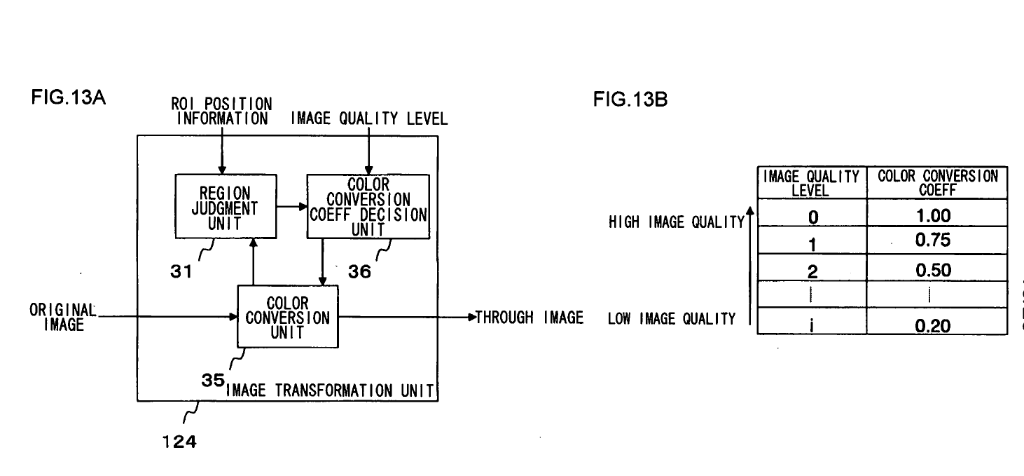

FIG. 13A shows a structure of the image transformation unit 124 in this embodiment. The image transformation unit 124 includes a color conversion unit 35, a region judgment unit 31, and a color transformation coefficient decision unit 36. The color conversion unit 35 performs color conversion by multiplying the color difference data of each pixel of the input original image by a color conversion coefficient, and thereby generates a through image. The color conversion is done by the following expression.
TPC(x,y)=aC(x,y)OPC(x,y) (2)

Here, OPC represents color difference data of the original image, TPC represents color difference data of a through image, and (x,y) represents the pixel location in each image. The each color difference data of both the original image and the through image may take a range of values −128 to 127. Here, aC(x,y) represents a color transformation coefficient in the pixel (x,y) of the original image.

This color conversion coefficient aC(x,y) is determined by the following method. The color conversion unit 35 sends the coordinate position (x,y) of the pixel subject to the color conversion to the region judgment unit 31. When receiving the coordinate position information of the pixel from the color conversion unit 35, the region judgment unit 31 compares it with the ROI position information output from the ROI region setting unit 123 and judges whether the pixel subject to the color conversion is located in the region of interest or not. If a plurality of the regions of interest exist, the region judgment unit 31 judges which region of interest the pixel is located in. The region judgment unit 31 outputs the judgment result to the color conversion coefficient decision unit 36.

The color conversion coefficient decision unit 36 specifies an image quality level of the region which the pixel subject to the color conversion belongs to, according to the result of the region judgment unit 31 and the image quality level of each region output from the image quality setting unit 128, and outputs the color conversion coefficient ac(x,y) corresponding to the specified image quality level to the color conversion unit 35. The correspondence between the image quality level and the color conversion coefficient is stored as a table in the color conversion coefficient decision unit 36. FIG. 13B is an example of the table that stores the correspondence between the image quality level and the color conversion coefficient. In this table, the color conversion coefficients are defined for the image quality levels 0 to i. A value close to 1 is stored as a color conversion coefficient in the table at the image quality level corresponding to a higher image quality, while a value close to 0 is stored as a color conversion coefficient at the image quality level corresponding to a lower image quality. By this, the color level of the region of a high image quality can be kept at a level close to the original image and the color level of the region of a low image quality is kept low. Therefore, the through image output by the image transformation unit 124 is an image in which the region of a lower image quality level becomes a colorless image, namely, one close to a black and white image, so that the difference in the image quality level can be easily recognized.

The color conversion coefficients need not be prepared for all the image quality levels in the table, and the color conversion coefficients may be prepared only for a typical image quality level. In this case, if the image quality level that does not exist in the table is specified, a color conversion coefficient near the specified image quality level is output to the color conversion unit 35.

Although there are two kinds of color difference data, namely, Cb and Cr, the same table that stores the correspondence between the image quality level and the color conversion coefficient may be used for the two kinds or two different tables may be prepared and used. Moreover, only either one of the color difference data Cb and Cr may be converted by the expression (2), while as for another color difference data, the data of the original image may be output as data for the through image.

According to the above-mentioned configuration, when the encoding unit 125 performs encoding, the image transformation unit 124, by a simple structure, can generate the image in real time in which the image quality level of each region set by the ROI region setting unit 123 is represented by the difference in the color level, and display this image on the display device 140. Moreover, since the difference in the image quality level of each region when it is encoded is displayed as the difference in color, the image is clearly displayed in all regions. Therefore, there is an advantage that the user can recognize in real time the image quality level of each region of the coded image and the user also can recognize in all regions the contents that appear in the entire image.

### Sixth Embodiment

A digital camera 100 according to the sixth embodiment has the same structure as that of FIG. 1, however, the function of the image transformation unit 124 is different. The image transformation unit 124 in this embodiment has a function of performing the process for shading the image. The image transformation unit 124 performs a shading process on the image data (original image) input from the frame buffer 122 so that the image quality of each region set by the ROI region setting unit 123 can differ. The shading process is to substitute pixel data with a black or gray level at a constant rate.

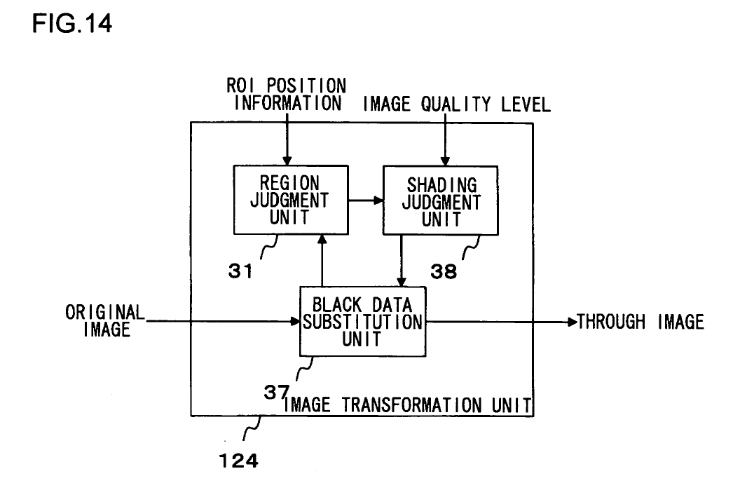

FIG. 14 shows a structure of the image transformation unit 124 in this embodiment. The image transformation unit 124 includes a black data substitution unit 37, a region judgment unit 31, and a shading judgment unit 38. For the pixel specified by the after-mentioned shading judgment units 38 among pixels of the input original image, the black data substitution unit 37 substitutes the pixel value with black data. Specifically, both brightness and color difference of the pixel data subject to the black data substitution is substituted with zero. For the other data, the pixel values of the original image is output as it is as the through image.

The pixel to be substituted with black data is determined by the following method. The black data substitution unit 37 sends the coordinate position of the pixel to be processed to the region judgment unit 31. When receiving the coordinate position information of the pixel from the black data substitution unit 37, the region judgment unit 31 compares it with the ROI position information output from the ROI region setting unit 123 and judges whether the pixel subject to the process is located in the region of interest or not. If a plurality of the regions of interest exist, the region judgment unit 31 judges which region of interest the pixel is located in. The region judgment unit 31 outputs the judgment result to the shading judgment unit 38.

The shading judgment unit 38 specifies the image quality level of the region which the pixel to be processed belongs to, according to the result of the region judgment unit 31 and the image quality level of each region output from the image quality setting unit 128. In accordance with this specified image quality level, the shading judgment unit 38 determines a ratio of pixels to be substituted with black data in the region that the pixel to be processed belongs to. Then, the shading judgment unit 38 judges whether to substitute the pixel to be processed with the black level according to the determined ratio of pixels to be substituted with black data, and sends this information to the black data substitution unit 37.

The correspondence between the image quality level and the ratio of pixels to be substituted with black data is stored as a table in the shading judgment unit 38. In this table, the ratio of pixels to be substituted with black data is defined for a plurality of the image quality levels. The ratio of pixels to be substituted with black data is close to 0 for the image quality level corresponding to a higher image quality and the ratio is 0 for the highest image quality level. In this case, in the region of a high quality, each pixel of the original image is output almost as it is as a through image. On the other hand, in this table, the ratio of pixels to be substituted with black data which becomes close to 1 for the image quality level corresponding to a lower image quality. By this, a large number of pixels that belongs to the region of low image quality are substituted with the black level. Therefore, the through image output by the image transformation unit 124 will be an image in which the density of the shading becomes larger for the region of a lower image quality level.

The ratios of pixels to be substituted with black data need not be prepared for all the image quality levels in the table, and the ratios may be prepared only for a typical image quality level. In this case, if the image quality level that does not exist in the table is specified, a ratio near the specified image quality level is set.

According to the above-mentioned configuration, when the encoding unit 125 performs encoding, the image transformation unit 124 can generate the image in real time in which the image quality level of each region set by the ROI region setting unit 123 is represented by the difference in the density of the shading, and display this image on the display device 140. Therefore, there is an advantage that the user can recognize in real time at what image quality level each region will be encoded in the coded image in which a plurality of regions have different image qualities, while viewing the image displayed on the display apparatus. Moreover, since the shading process can be performed by substituting the pixel data for every predefined pixel interval, it can be easily implemented by a simple structure.

In this embodiment, the image transformation unit 124 substitutes the pixel data with black data at a constant ratio, however, the pixel data may be substituted with certain constant color data (for instance, gray data) instead of black data.

The embodiments described above are only exemplary and it is understood by those skilled in the art that there may exist various modifications to the combination of such each component and process. Such modifications are hereinafter described.

For instance, in the embodiments of the present invention, image quality conversion, brightness conversion, color conversion, and shading are exemplified as the image transformation by the image transformation unit 124 and a different structure for each transformation is described. However, instead of having such a specialized structure, the apparatus may have one filter as shown in FIG. 7 and image quality conversion, brightness conversion, color conversion, and shading may be realized by changing the coefficients of the filter.

In this case, when the image quality conversion is performed by the filter of FIG. 7, the filter coefficients can be set as described in the first embodiment. To perform brightness conversion, the brightness conversion coefficient shown in the table of FIG. 12B is set to the filter coefficient am for the brightness data, and the other filter coefficients are all set to 0. In this case, the color difference data is output without passing through the filter or the filter coefficient am is set to 1 and the other coefficients to 0.

To perform color conversion, contrary to the brightness conversion, the color conversion coefficient shown in the table of FIG. 13B is set to the filter coefficient am for the color difference data, and the other filter coefficients are all set to 0. In this case, the brightness data is outputs without passing through the filter or the filter coefficient am is set to 1 and the other coefficients to 0.

To perform shading, if the pixel data of the original image is substituted with black data, all filter coefficients is set to 0. Otherwise, the filter coefficient am is set to 1 and the other coefficients are set to 0. The shading is thereby realized.

According to this configuration, a user can select any one of image quality, brightness, color and shading density as a method for expressing the image quality level of each region in the through image displayed on the display device. Therefore, the convenience of the user can be improved.

In the embodiments of the present invention, an example is shown in which the encoding unit encodes the image by JPEG2000 scheme, however, any other encoding methods for encoding a plurality of regions in different image qualities can be applied.

Moreover, in the embodiments of the present invention, a digital camera is exemplified which sets a region of interest while leaving the other regions as regions of non-interest, and encodes each region in a different image quality, however, a digital camera, for instance, which sets a region of non-interest is also within the scope of the present invention. Furthermore, an image may also be divided into a plurality of regions according to their respective degrees of priority without making a distinction between the region of interest and the region of non-interest. In the above embodiments, a region of non-interest and a plurality of regions of interest are given an order of priority among them, which practically means that the region of non-interest and the regions of interest have differences in the degree of priority only. It further means that the similar processing can be applied even to a case where an image is divided into regions for each different degree of priority without making any distinction between the region of non-interest and the regions of interest.

In addition, a digital camera is explained throughout the above-mentioned embodiments, however, the embodiments of present invention are not restricted to such a digital camera. For instance, an image processing apparatus that sets a region of interest for an image once recorded in a storage device and encodes the image is within the scope of the present invention.

The seventh embodiment to the eleventh embodiment of the present invention are now described hereinafter. These embodiments relate to an image processing apparatus.

### Seventh Embodiment

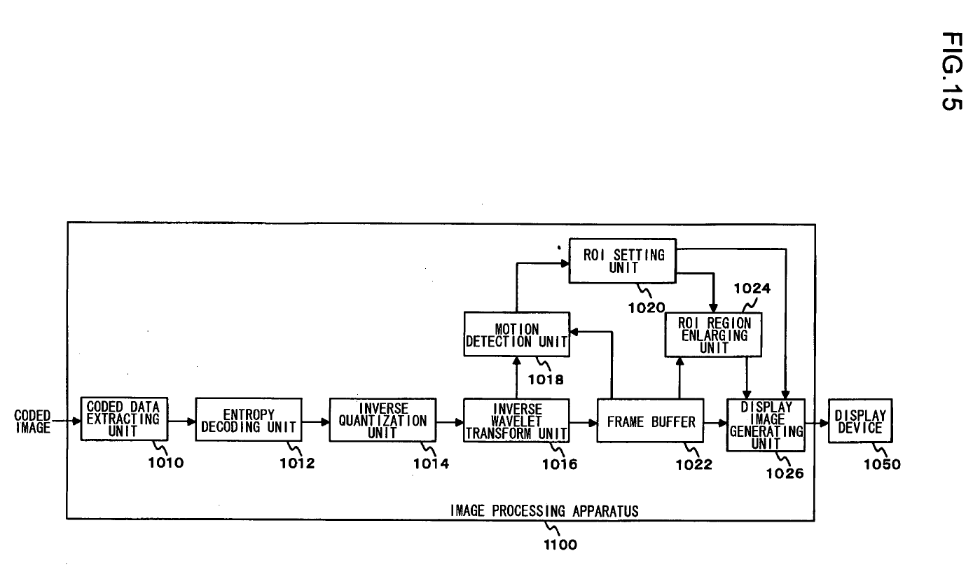

FIG. 15 illustrates a structure of an image processing apparatus 1100 according to the seventh embodiment of the present invention. In terms of hardware, this structure of the image processing apparatus 1100 can be realized by a CPU, a memory and other LSIs of an arbitrary computer. In terms of software, it can be realized by memory-loaded programs which have decoding functions or the like, but drawn and described herein are function blocks that are realized in cooperation with those. Thus, it is understood by those skilled in the art that these function blocks can be realized in a variety of forms such as by hardware only, software only or the combination thereof.

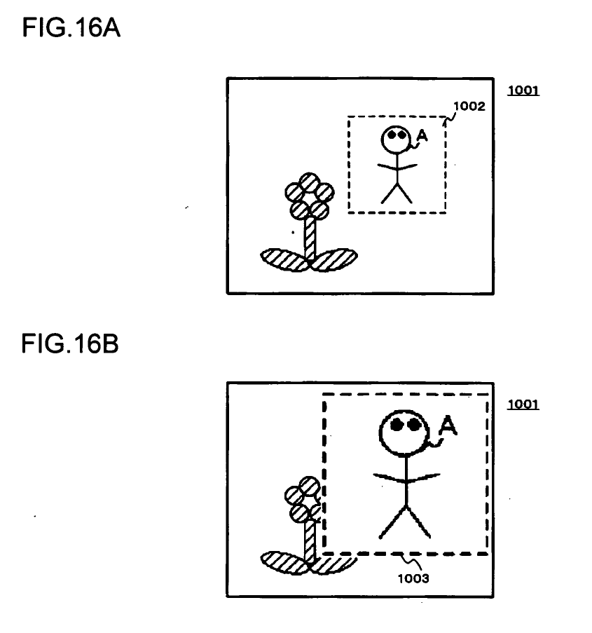

In the seventh embodiment, the image processing apparatus 1100 decodes a coded image that has been compression-encoded, for instance, by JPEG2000 scheme (ISO/IEC 15444-1:2001), and generates an image to be displayed on the display device 1050. At decoding, the image processing apparatus 1100 specifies a region of interest 1002, (hereafter, it is referred to as a ROI region) in the original image 1001, and enlarges the ROI region 1002, as shown in FIG. 16A. Then, the image processing apparatus 1100 superimposes this enlarged ROI region 1003 in the position of the ROI region 1002 in the original image 1001 as shown in FIG. 16B and enables the display device 1050 to display it. The image processing apparatus 1100 and the display device 1050 are an example of an image display apparatus of the present invention.

The coded image input to the image processing apparatus 1100 may be a coded frame of a moving image. A moving image can be reproduced by consecutively decoding coded frames of the moving image, which are input as a codestream.

A coded data extracting unit 1010 extracts coded data from an input coded image. An entropy decoding unit 1012 decodes the coded data bit-plane by bit-plane and stores the resulting quantized wavelet transform coefficients in a memory that is not shown in the figure.

An inverse quantization unit 1014 inverse-quantizes the quantized wavelet transform coefficients obtained by the entropy decoding unit 1012. An inverse wavelet transform unit 1016 inverse-transforms the wavelet transform coefficients inverse-quantized by the inverse quantization unit 1014, and decodes the image frame by frame. The image decoded by the inverse wavelet transform unit 1016 is stored in a frame buffer 1022 frame by frame.

A motion detection unit 1018 detects the position of a specified object and outputs the detected position to a ROI setting unit 1020. The object may be specified by a user, or the motion detection unit 1018 may recognize the object automatically in the ROI region specified by a user. Moreover, an object may be automatically detected from the entire image. A plurality of the objects may be specified.

In the case of a motion image, the position of the object can be represented by a motion vector. Hereafter, some concrete examples of the motion vector detection method are described. As the first method, the motion detection unit 1018, which provides with a memory such as SRAM or SDRAM, preserves as a reference image in the memory the image of the object specified in the frame when the object is specified. A block of a predetermined size including a specified position may be preserved as a reference image. The motion detection unit 1018 detects the motion vector by comparing the reference image with the image of a current frame. The calculation of the motion vector can be done by specifying an outline element of the object by using the high-frequency component of the wavelet transform coefficients. Moreover, the MSB (Most Significant Bit) bit-plane of the quantized wavelet transform coefficients or a plurality of bit-planes taken from the MSB side may be used for the calculation.

As the second method, the motion detection unit 1018 compares the current frame to a precious frame, for instance, an immediately preceding frame, and thereby detects the motion vector of the object. As the third method, the motion detection unit 1018 compares, instead of the frame image, the wavelet transform coefficients after the wavelet transform, and thereby detects the motion vector. As the wavelet transform coefficients, any one of the LL sub-band, HL sub-band, LH sub-band, and HH sub-band may be used. Moreover, the image to be compared to the current frame may be a reference image registered when it is specified, or may be a reference image registered for a precious frame, for instance, an immediately preceding frame.

As the fourth method, the motion detection unit 1018 detects the motion vector of the object by using a plurality of sets of the wavelet transform coefficients. For instance, the motion vectors may be detected respectively for the HL sub-band, the LH sub-band, and HH sub-band, and the average of these three motion vectors may be obtained, or the one that is closest to the motion vector for a previous frame may be selected among these motion vectors. As a result, the motion detection accuracy for the object can be improved.

Moreover, a user may specify for the motion detection unit 1018 beforehand a range where such a motion vector is detected in the image. For instance, in decoding the image taken by a surveillance camera in a store such as a convenience store, a process can be done in such a manner that an object such as a person who entered a constant range from the cash register will be given attention, and the movement of the object that has gone out of the range will not be given attention any longer.

The ROI setting unit 1020 obtains position information such as the motion vector of the object from the motion detection unit 1018, and moves the ROI region in accordance with the position information. According to the detection method by the motion detection unit 1018, the amount of movement from the initial position of the ROI region or the amount of movement from the immediately preceding frame is calculated and the position of the ROI region in the current frame is determined. The ROI setting unit 1020 is an example of a means of this invention for setting a region of interest for an image.

A user sets as initial values for the ROI setting unit 1020 the position and size of the ROI region for the image (hereinafter, it is referred to as the original image) decoded by the inverse wavelet transform unit 1016. If a ROI region is selected as the form of a rectangle, the position information of the ROI region may be given by coordinate values of a pixel at the upper left corner of the rectangular region and the number of pixels in the vertical and horizontal directions of the rectangular region. If a user specifies an object or if the motion detection unit 1018 automatically recognizes an object with movement, the ROI setting unit 1020 may automatically set as the ROI region a predetermined range of the area which contains the object.

The shape of the ROI region may be a rectangle, circle, or any other complicated figures. The shape of the ROI region should be fixed, in principle, however, the shape of the region may be changeable depending on whether the region is the central part of the image or the periphery thereof, or the shape may be dynamically changeable by a user operation. Moreover, a plurality of ROI regions may be set.

The user sets for the ROI setting unit 1020 as an initial value a scale of enlargement when the ROI region is enlarged and displayed. As the scale of enlargement, different values may be set in the vertical direction and the horizontal direction. Moreover, if a plurality of ROI regions exist, a different scale of enlargement may be set in each region.

A ROI region enlarging unit 1024 obtains the position information of the ROI region set by the ROI setting unit 1020, and extracts the image of the ROI region from the original image stored in the frame buffer 1022. The ROI region enlarging unit 1024 performs an enlargement process on the image of the ROI region according to the scale of enlargement set by the ROI setting unit 1020. The ROI region enlarging unit 1024, which comprises a memory such as SRAM or SDRAM, preserves the data of the enlarged ROI region in this memory.

If a plurality of ROI regions are defined, the image of all of the ROI regions may be read from the frame buffer 1022, and the enlargement process may be performed on each of the ROI regions according to the specified scale of the enlargement. Alternatively, only a subset of the ROI regions may be read and the enlargement process may be performed on the subset of the ROI regions. The ROI region enlarging unit 1024 is an example of a means of this invention for enlarging a region of interest. Moreover, a combination of the respective functions of the motion detection unit 1018, the ROI setting unit 1020 and the ROI region enlarging unit 1024 is an example of a means of this invention for making the enlarged region of interest follow to movement of an object in the region of interest.

The display image generating unit 1026 reads the original image from the frame buffer 1022. On the other hand, for the image corresponding to the position of the ROI region set on the original image and the peripheral region thereof, the display image generating unit 1026 reads the data of the enlarged ROI region preserved by the ROI region enlarging unit 1024, instead of reading the image from the frame buffer 1022, and generates an image to be displayed on the display device 1050.

If a plurality of ROI regions are defined, the display image generating unit 1026 reads, instead of the original image, the data of all ROI regions enlarged by the ROI region enlarging unit 1024, and generates an image to be displayed. At this time, if there is an overlapped region between the plurality of the ROI regions, the data of the ROI region with a high priority is read and the ROI region with a high priority is displayed in front. This order of priority is determined, for instance, depending on the scale of enlargement defined for each ROI region or the size of the enlarged ROI region. Alternatively, the order of priority may be manually set for each ROI region. The display image generating unit 1026 and the display device 1050 is an example of means of this invention for displaying an image.

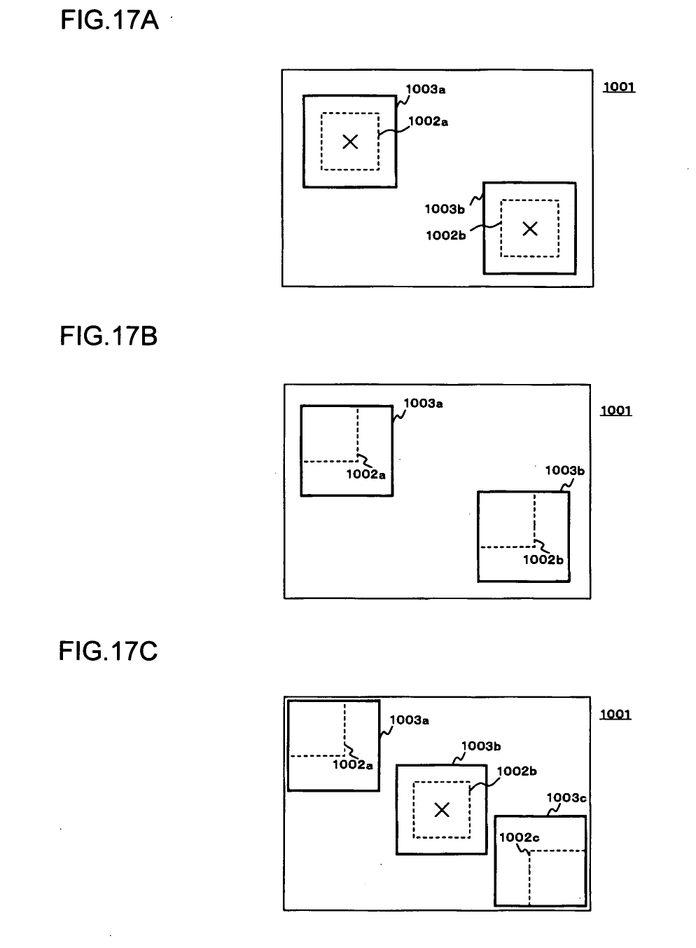

FIGS. 17A to 17C show an example of a positional relation of the enlarged ROI region for the ROI region set in the original image. For instance, FIG. 17A shows a positional relation in which the center of the ROI region (1002a, 1002b) set in the original image 1001 and the center of the enlarged ROI region (1003a, 1003b) always agree. FIG. 17B shows a positional relation in which the upper left point (1002a, 1002b) of the ROI region set in the original image 1001 and the upper left point (1003a, 1003b) of the enlarged ROI region always agree. FIG. 17C shows the following positional relation. If a ROI region is set around the center of the original image 1001, the center of the ROI region (1002b) and the center of the enlarged ROI region (1003b) agree. If a ROI region is set in the left region of the original image 1001, the left ends of the ROI region (1002a) set in the original image 1001 and the enlarged ROI region (1003a) agree. If a ROI region is set in the right region of the original image 1001, the right ends of the ROI region (1002c) set in the original image 1001 and the enlarged ROI region (1003c) agree. If a ROI region is set in the upper region of the original image 1001, the upper ends of the ROI region (1002a) set in the original image 1001 and the enlarged ROI region (1003a) agree. If a ROI region is set in the lower region of the original image 1001, the lower ends of the ROI region (1002c) set in the original image 1001 and the enlarged ROI region (1003c) agree. A user may set as an initial value for the display image generating unit 1026 the relation of the position of the ROI region set in the original image and the display position of the enlarged ROI region.

In the case of FIG. 17A and FIG. 17B, a part of the enlarged ROI region might go out of the original image 1001. In this case, the display position may be adjusted so that the enlarged ROI region might not go out of the original image 1001.

In FIG. 17, an area that belongs to the region (1003a, 1003b, 1003c) where the enlargement ROI region is displayed but does not belong to the ROI region (1002a,1002b,1002c) set in the original image is the above-mentioned peripheral region of the ROI region.

The operation of the image processing apparatus 1100 shown in FIG. 15 is hereafter described on the basis of the above-mentioned structure. The coded image input to the image processing apparatus 1100 is decoded through the coded data extracting unit 1010, the entropy decoding unit 1012, the inverse quantization unit 1014, and the inverse wavelet transform unit 1016, and then the decoded image is stored in the frame buffer 1022. If a user does not instruct to display a ROI region, the image stored in the frame buffer 1022 is processed in the display image generating unit 1026 and displayed on the display device 1050.

On the other hand, if a user instructs to display a ROI region, the ROI setting unit 1020 determines an initial position and size of the ROI region by the above-mentioned method, and sets the ROI region for the decoded image stored in the frame buffer 1022. Moreover, while a motion image is continuously decoded from the coded image, the motion detection unit 1018 detects the movement of an object of interest in the defined ROI region and the ROI setting unit 1020 makes the ROI region follow the movement of this object and sets the ROI region for each frame image that composes the motion image.

Next, the ROI region enlarging unit 1024 reads from the frame buffer 1022 the image of the ROI region set by the ROI setting unit 1020, performs the enlargement process, and preserves the data of the enlarged ROI region. Then, the display image generating unit 1026 reads the image stored in the frame buffer 1022. As for the ROI region in the original image and the peripheral region thereof, the display image generating unit 1026 reads, instead of the image in the frame buffer 1022, the data of the enlarged ROI region preserved by the ROI region enlarging unit 1024 and generates an image to be displayed. This image to be displayed is displayed by the display device 1050.

As mentioned above, according to the image processing apparatus 1100 of this embodiment, a ROI region can be set for the coded image and the ROI region can be enlarged and displayed on the display device 1050. Moreover, if an object of interest in the ROI region moves, the ROI region also moves following the movement of this object automatically. As a result, the object of user interest can be easily made to stand out.

### Eighth Embodiment

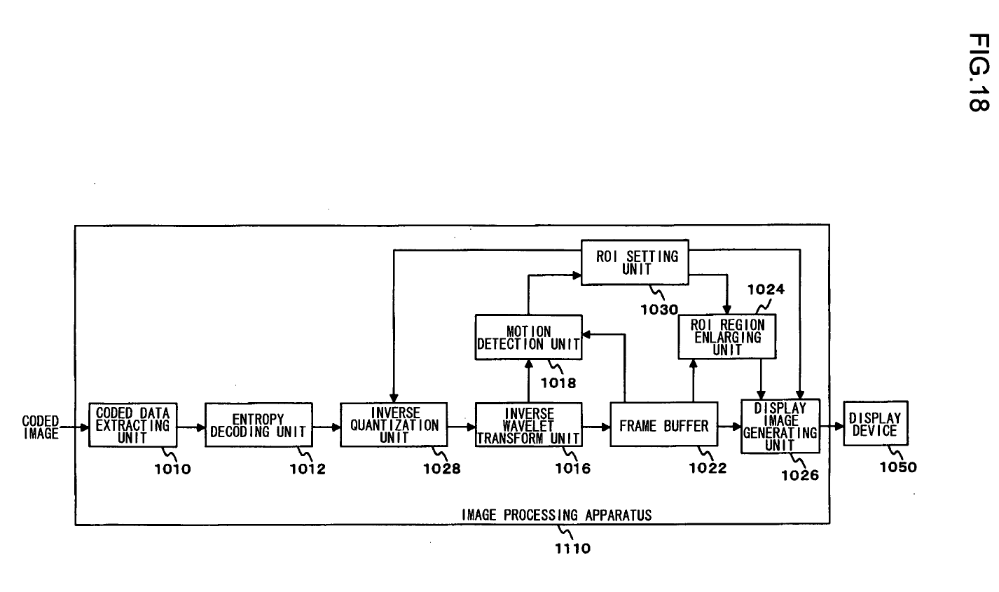

FIG. 18 illustrates a structure of an image processing apparatus 1110 according to the eighth embodiment. The image processing apparatus 1110 is configured in such a manner that the inverse quantization unit 1014 and the ROI setting unit 1020 of the image processing apparatus 1100 according to the seventh embodiment are replaced by the inverse quantization unit 1028 and the ROI setting unit 1030. Hereinbelow, the same reference numerals will be used for a structure equal to that of the seventh embodiment, and its description will be omitted.

The ROI setting unit 1030 operates as the ROI setting unit 1020, and additionally generates ROI masks to specify the wavelet transform coefficients corresponding to the ROI region, that is, the ROI transform coefficients based on the ROI setting information. The inverse quantization unit 1028 adjusts the number of low-order bits to be substituted with zeros in a bit string of the above-mentioned wavelet transform coefficients corresponding to a region of non-interest (hereinafter, it is referred to as non-ROI region) according to a relative degree of priority of the ROI region to the non-ROI region. Then, by referring to the above-mentioned ROI masks, the inverse quantization unit 1028 performs a zero-substitute processing on a predetermined number of bits selected from the LSB (Least Significant Bit) side of the non-ROI transform coefficients among the wavelet transform coefficients decoded by the entropy decoding unit 1012.

Here, the number of bits to be substituted with zeros is an arbitrary natural number the upper limit of which is the maximum bit number of quantized values in the non ROI. By varying this zero-substitution bit number, the level of degradation in reproduced image quality of the non-ROI region relative to ROI region can be continuously adjusted. Then, the inverse quantization unit 1028 inverse-quantizes the wavelet transform coefficients including the ROI transform coefficients and the non-ROI transform coefficients the lower bits of which are zero-substituted. The inverse wavelet transform unit 1016 inverse-transforms the inverse-quantized wavelet transform coefficients and outputs the obtained decoded image to the frame buffer 1022.

The ROI masks generated by the ROI setting unit 1030 is now described referring to FIGS. 4A to 4C described in the first embodiment. As shown in FIG. 4A, suppose that a ROI region 90 is selected on the original image 80 by the ROI setting unit 1030. The ROI setting unit 1030 specifies, in each sub-band, wavelet transform coefficients necessary for restoring the selected ROI region 90 on the original image 80.

FIG. 4B shows a first-hierarchy transform image 82 obtained by performing one-time wavelet transform on the original image 80. The transform image 82 in the first hierarchy is composed of four first-level sub-bands which are represented here by LL1, HL1, LH1 and HH1. In each of the first-level sub-bands of LL1, HL1, LH1 and HH1, the ROI setting unit 1030 specifies wavelet transform coefficients on the first-hierarchy transform image 82, namely, ROI transform coefficients 91 to 94 necessary for restoring the region of interest 90 in the original image 80.

FIG. 4C shows a second-hierarchy transform image 84 obtained by performing another wavelet transform on the sub-band LL1 which is the lowest-frequency component of the transform image 82 shown in FIG. 4B. Referring to FIG. 4C, the second-hierarchy transform image 84 contains four second-level sub-bands which are composed of LL2, HL2, LH2 and HH2, in addition to three first-level sub-bands HL1, LH1 and HH1. In each of the second-level sub-bands of LL2, HL2, LH2 and HH2, the ROI setting unit 1030 specifies wavelet transform coefficients on the second-hierarchy transform image 84, namely, ROI transform coefficients 95 to 98 necessary for restoring the ROI transform coefficient 91 in the sub-band LL1 of the first-hierarchy transform image 82.

In the similar manner, by specifying recursively the ROI transform coefficients that correspond to the ROI region 90 at each hierarchy for a certain number of times corresponding to the number of wavelet transforms done, all ROI transform coefficients necessary for restoring the ROI region 90 can be specified in the final-hierarchy transform image. The ROI setting unit 1030 generates a ROI mask for specifying the position of this finally specified ROI transform coefficient in the last-hierarchy transform image. For example, when the wavelet transform is carried out two times only, generated are ROI masks which can specify the position of seven ROI transform coefficients 92 to 98 which are represented by areas shaded by oblique lines in FIG. 4C.

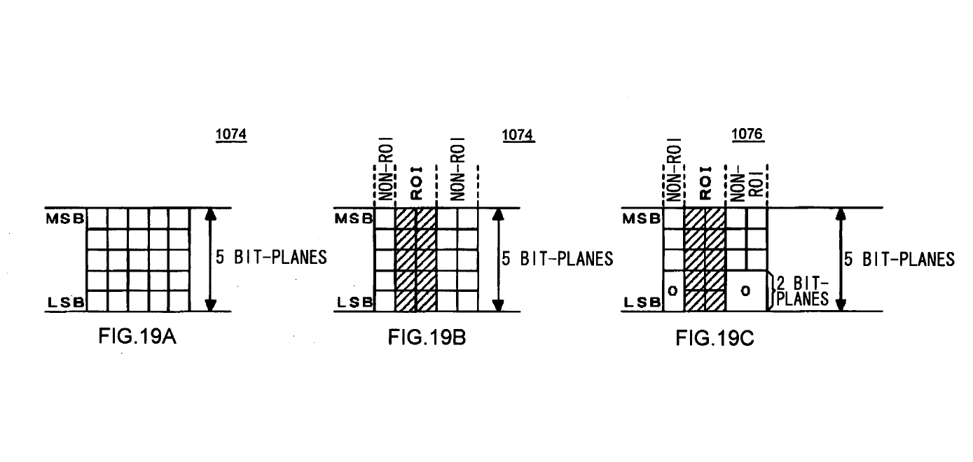

FIGS. 19A to 19C illustrate how the low-order bits of the decoded wavelet transform coefficients of the coded image are zero-substituted. FIG. 19A shows the wavelet transform coefficients 1074 of the entropy-decoded image, which contain 5 bit-planes. The ROI transform coefficients corresponding to the ROI region specified by the ROI setting unit 1030 are represented by the area shaded by oblique lines in FIG. 19B. The inverse quantization unit 1028 generates the wavelet transform coefficients 1076 in which the two low bits of the non-ROI transform coefficients are substituted with zeros as shown in FIG. 19C.

It should be noted that the ROI setting unit 1030 may also select a non-ROI region instead of a ROI region. For example, if a user wants regions containing personal information, such as a face of a person or a license plate of a car, to be blurred, the arrangement may be such that the ROI setting unit 1030 selects such regions as non-ROI region. In this case, the ROI setting unit 1030 can generate a mask for specifying ROI transform coefficients by inverting the mask for specifying the non-ROI transform coefficients. Or the ROI setting unit 1030 may give the mask for specifying the non-ROI transform coefficients to the inverse quantization unit 1028.

When coded frames of a moving image are consecutively input to the image processing apparatus 1110, the image processing apparatus 1110 can carry out the following operation. That is, the image processing apparatus 1110 normally performs a simplified reproduction by appropriately discarding low-order bit-planes of wavelet transform coefficients in order to reduce processing load. Because of this disposal of lower bit-planes, a simplified reproduction at, for instance, 30 frames per second is possible even when the image processing apparatus 1110 is subject to limitations in its processing performance.

When a ROI region in an image is selected during a simplified reproduction, the image processing apparatus 1110 reproduces the image by decoding, down to the lowest-order bit-plane, the wavelet transform coefficients for which the low-order bits of the non-ROI region have been zero-substituted. At this time, the processing load rises, and the result may be a loss of frames to 15 frames per second, for instance, or a slowed reproduction, though the ROI region can be enlarged and reproduced with a high image quality.

Thus, when a ROI region is selected in this manner, the ROI region only will be enlarged and reproduced with a higher quality while the quality of the non-ROI regions remains at a level equal to a simplified reproduction. This proves useful for such applications as a surveillance camera which do not require high-quality images at normal times but have need for higher-quality reproduction of a ROI region in times of emergency. For reproduction of moving images by a mobile terminal, the image processing apparatus 1110 may be used in the following manner, for example. That is, the moving images are reproduced with low quality in the power saving mode, with the ROI region reproduced with higher quality only when necessary, so as to ensure a longer life for the battery.

The image processing apparatus 1110 according to the present embodiment, therefore, can set a ROI region for a coded image and then decode the coded image, in such a manner that the image quality of the ROI region is relatively raised higher than that of the non-ROI regions by zero-substituting the low-order bits of the wavelet transform coefficients corresponding to the non-ROI regions. Therefore, the ROI region can be enlarged and displayed with a higher image quality and an object of user interest can be easily made stand out. Since the ROI region only is decoded preferentially, the amount of computation can be decreased when it is compared with a normal decoding process. Therefore the speed of the process can be raised and the power consumption can be reduced.

### Ninth Embodiment

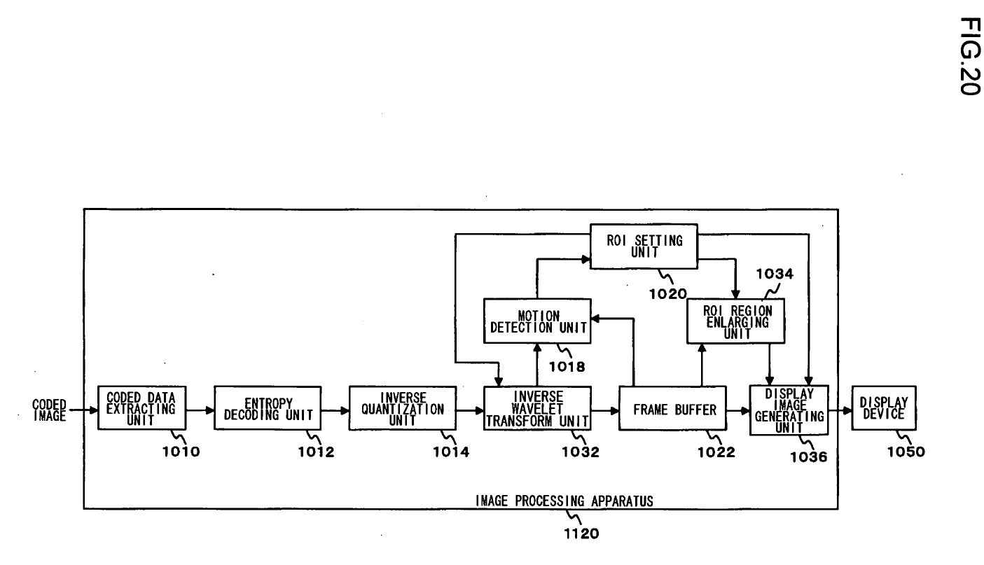

FIG. 20 illustrates a structure of an image processing apparatus 1120 according to the ninth embodiment. The image processing apparatus 1120 is configured in such a manner that the inverse wavelet transform unit 1016, the ROI region enlarging unit 1024 and the display image generating unit 1026 of the image processing apparatus 1100 according to the seventh embodiment are replaced by the inverse wavelet transform unit 1032, the ROI region enlarging unit 1034 and the display image generating unit 1036. Hereinbelow, the same reference numerals will be used for a structure equal to that of the seventh embodiment, and its description will be omitted.

The inverse wavelet transform unit 1032 aborts the inverse wavelet transform process at a stage on the way, and sends the LL sub-band image of a low resolution obtained at the stage to the frame buffer 1022. If a ROI region is specified by the ROI setting unit 1020, this ROI region only is subject to the inverse wavelet transform to the end and an image of a high resolution is obtained. This high resolution image is sent to the frame buffer 1022 and stored in an area other than the area where the above-mentioned LL sub-band image is stored.

The ROI region enlarging unit 1034 reads the ROI region decoded in a high resolution stored in the frame buffer 1022, and performs an enlargement processing according to the scale of enlargement set by the ROI setting unit 1020. The display image generating unit 1036 enlarges the LL sub-band image stored in the frame buffer 1022 into the size of the original image, and then superimposes the ROI region enlarged by the ROI region enlarging unit 1034, and thereby generates an image to be displayed on the display apparatus 1050.

When coded frames of a moving image are consecutively input to the image processing apparatus 1120, the image processing apparatus 1120 can carry out the following operation, as in the eighth embodiment. That is, in order to reduce processing load, the image processing apparatus 1120 normally performs a simplified reproduction in which the inverse wavelet transform is aborted at a stage on the way and a low resolution image obtained at the stage on the way is reproduced. Because of this termination of the inverse wavelet transform at a midterm stage, a simplified reproduction at, for instance, 30 frames per second is possible even when the image processing apparatus 1120 is subject to limitations in its processing performance.

When a ROI region in an image is selected during a simplified reproduction, the image processing apparatus 1120, for the non-ROI regions, aborts the inverse wavelet transform at a midterm stage and reproduces a low resolution image obtained at the midterm stage as in a normal case. On the other hand, the image processing apparatus 1120 reproduces an image for the ROI region by performing the inverse wavelet transform to the end and decoding a high resolution image and then enlarging it. At this time, the processing load rises, and the result may be a loss of frames to 15 frames per second, for instance, or a slowed reproduction, though the ROI region can be enlarged and reproduced with a high image quality.

Thus, when a ROI region is selected in this manner, the region of interest only will be enlarged and reproduced with a higher quality while the quality of the non-ROI regions remains at a level equal to a simplified reproduction. This proves useful for such applications as a surveillance camera which do not require high-quality images at normal times but have need for higher-quality reproduction of a ROI region in times of emergency. For reproduction of moving images by a mobile terminal, the image processing apparatus 1110 may be used in the following manner, for example. That is, the moving images are reproduced with low quality in the power saving mode, with the ROI region reproduced with higher quality only when necessary, so as to ensure a longer life for the battery.

The image processing apparatus 1120 according to the present embodiment, therefore, can set a ROI region for a coded image and then decode the coded image, in such a manner that the resolution of the ROI region is relatively raised higher than that of the non-ROI regions by aborting the inverse wavelet transform for the non-ROI regions at a midterm stage while performing the inverse wavelet transform for the ROI region to the end. Thereby, even when the ROI region is enlarged, the ROI region can be displayed in detail with a fine quality and an object of user interest can be more easily made stand out. Since the ROI region only is decoded preferentially, the amount of computation can be decreased when it is compared with a normal decoding process. Therefore the speed of the process can be raised and the power consumption can be reduced.

### Tenth Embodiment

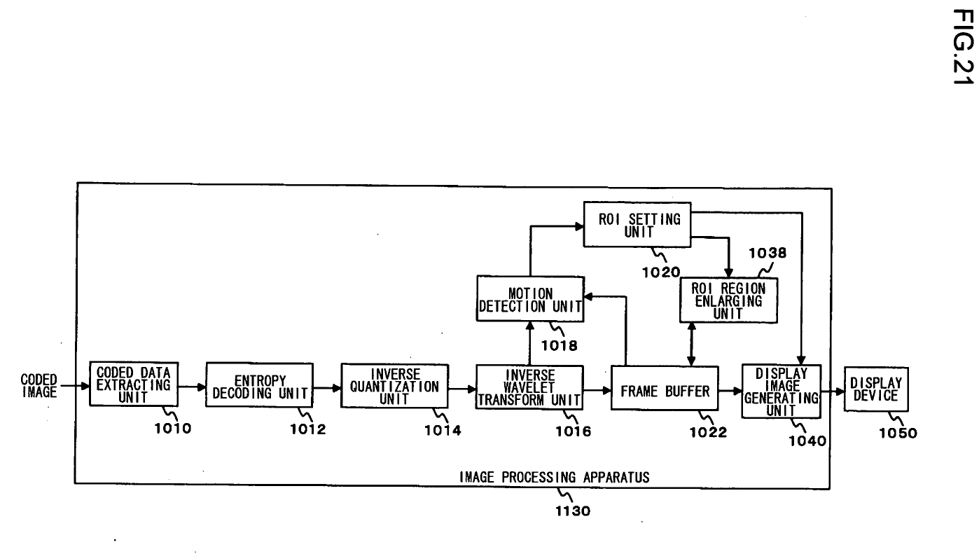

FIG. 21 illustrates a structure of an image processing apparatus 1130 according to the tenth embodiment. The image processing apparatus 1130 is configured in such a manner that the ROI region enlarging unit 1024 and the display image generating unit 1026 of the image processing apparatus 1100 according to the seventh embodiment are replaced by the ROI region enlarging unit 1038 and the display image generating unit 1040. Hereinbelow, the same reference numerals will be used for a structure equal to that of the seventh embodiment, and its description will be omitted.

The ROI region enlarging unit 1038 does not comprise any memory to preserve the enlarged ROI region, and the data of the enlarged ROI region is written back to the frame buffer 1022. At this time, the data that corresponds to the region of interest in the image and the peripheral region thereof stored in the frame buffer 1022 are overwritten by the data of the enlarged ROI region.

The display image generating unit 1040 reads from the frame buffer 1022 the image data on which the data of the enlarged ROI region has been overwritten, and enables the display device 1050 to display it as a display image.

By the image processing apparatus 1130 according to the present embodiment, therefore, an image in which the region of interest is enlarged can be easily displayed and the data corresponding to the enlarged region of interest does not need to be separately preserved. Therefore, a capacity of a memory necessary for enlarging the region of interest can be reduced.

### Eleventh Embodiment

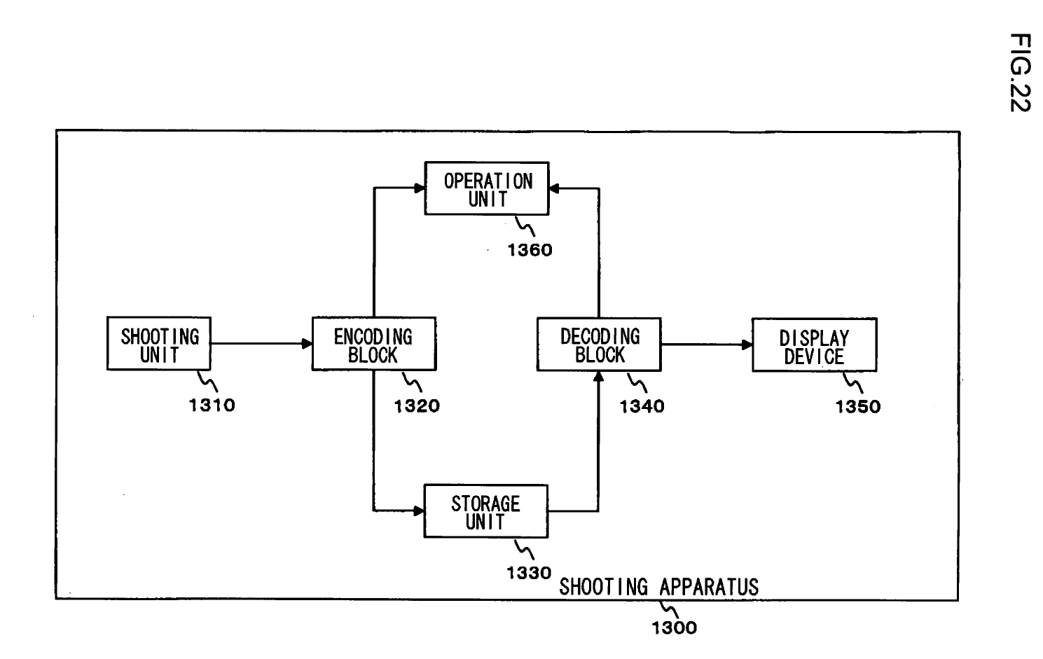

FIG. 22 illustrates a structure of a shooting apparatus 1300 according to the eleventh embodiment. An example of the shooting apparatus 1300 is a digital camera, a digital video camera, a surveillance camera, or the like.

A shooting unit 1310, which includes, for instance, CCD (Charge Coupled Device), takes in a light from an object and converts it into an electrical signal, and then outputs it to an encoding block 1320. The encoding block 1320 encodes an original image input from the shooting unit 1310, and stores the coded image in a storage unit 1330. The original image input to the encoding block 1320 may be a frame of a moving image, and frames composing a moving image may be consecutively encoded and stored in the storage unit 1330.

A decoding block 1340 reads the coded image from the storage unit 1330, decodes it and gives the decoded image to a display device 1350. The coded image read from the storage unit 1330 may be a coded frame of a moving image. The decoding block 1340 has a structure of any one of the image processing apparatus 1100, 1110, 1120, and 1130 according to the seventh to the tenth embodiment, and decodes the coded image stored in the storage unit 1330. Moreover, the decoding block 1340 receives from a operation unit 1360 information on a ROI region set on the screen and generates an image in which the ROI region is enlarged.

A display device 1350, which includes a liquid crystal display or an organic electroluminescence display, displays the image decoded by the decoding block 1340 therein. The operation unit 1360 can specify a ROI region or an object of interest on the screen of the display device 1350 by a user operation. For instance, a user may specify it, for instance, by moving a cursor or a frame in the image by operating arrow keys, or by using a stylus pen when a display with a touch panel is adopted. Additionally, the operation unit 1360 may have a shutter button and various types of operational buttons installed therein.

The shooting apparatus 1300 according to the present embodiment, therefore, can provide a shooting apparatus for easily making an object of user interest stand out.

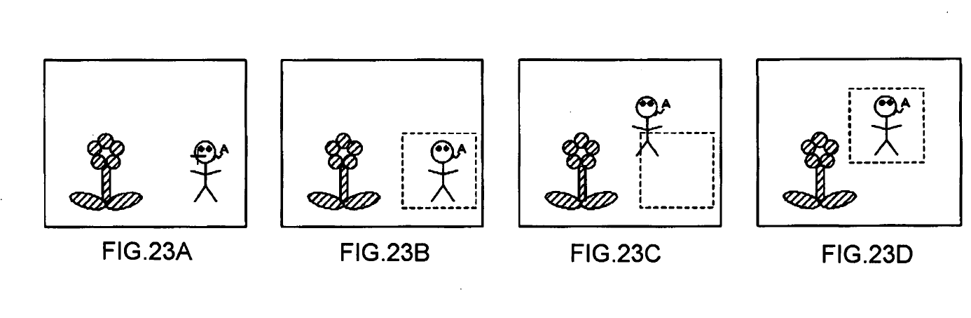

FIGS. 23A to 23D shows the first example of a process of making a ROI region follow that has been described above. FIG. 23A shows how a user specifies an object of interest in an image. A user specifies a person A to whom the user pays attention by a cross cursor. FIG. 23B shows how a ROI region is set in an image. The region enclosed by a frame is a ROI region. The ROI region may be initially set by a user operation, or may be automatically initialized to be a predetermined region including a specified object. FIG. 23C shows a scene in which the person A has moved out of the ROI region. FIG. 23D shows how the ROI region follows the movement of the person A. The motion vector of the person A is detected and the ROI region is moved in accordance with it.

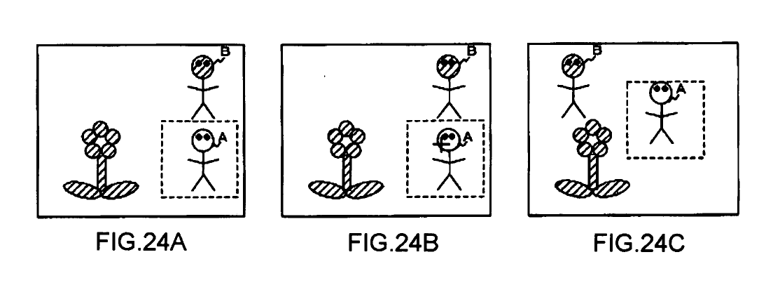

FIGS. 24A to 24C shows the second example of a process of making a ROI region follow. FIG. 24A shows how a user sets a ROI region in an image, unlike the procedure of the first example. Among a person A and a person B, a user sets the person A to be an object to which the user pays attention. A plurality of ROI regions may be set. FIG. 24B shows how a user specifies an object of interest in the ROI region. The object may be specified by a user or recognized automatically. FIG. 24C shows how the ROI region follows the movement of the person A. Since the person B is not specified as an object of user interest, its movement does not influence the movement of the ROI region.

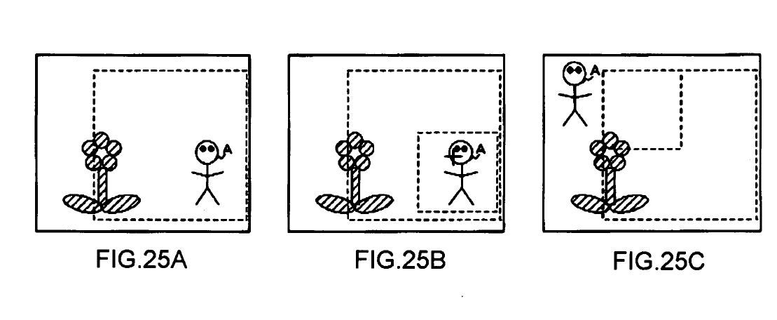

FIGS. 25A to 25C shows the third example of a process of making a ROI region follow. FIG. 25A shows how a range in which a ROI region follows is set. A large frame in the figure shows the range. FIG. 25B shows how a ROI region is set. This ROI region only moves within the specified large frame. FIG. 25C shows a scene in which the person A has moved out of the large frame. Since the ROI region only follows the person A within the large frame, the ROI region stops following on the way. If an object of user interest has moved out of the specified large frame, the shooting may be terminated. For instance, it is necessary to for a surveillance camera to especially record any person who has invaded a predetermined range of a specific region. In this case, it is sufficient to maintain an image quality of an object such as a person within the range. The third example can be applied for this case and can reduce the processing amount further than the first example and the second example.

It is needless to say that the shooting apparatus 1300 according to the eleventh embodiment can take a motion image and record it into a recording medium while performing a process for making the ROI region follow a specified object. Moreover, during the shooting, a user may operate the apparatus using the operation unit 1360 and release the setting of a ROI region and set the ROI region again. When the ROI region is released, all regions in the image are encoded at the same bit rate. The shooting of a motion image may be paused and then resumed by a user operation. In addition, the user can take a still image by pressing a shutter button in the operation unit 1360 during the process for making a ROI region follow a specified object. The still picture is one in which the ROI region is high image quality and the non-ROI region is low image quality.

The embodiments described above are only exemplary and it is understood by those skilled in the art that there may exist various modifications to the combination of such each component and process. Such modifications are hereinafter described.

In the above-mentioned embodiment, a coded stream of a coded motion image is consecutively decoded by JPEG2000 scheme, however, the decoding is not limited to JPEG2000 scheme and any other decoding schemes, in which a coded stream of a motion image is decoded, can be also used.

In the above-mentioned eighth embodiment, when a user sets a plurality of ROI regions for the ROI setting unit 1030, a different image quality may be set for each ROI region. The various levels of image quality can be achieved by adjusting the number of low-order bits to be substituted with zeros of non-ROI transform coefficients.

In the above-mentioned ninth embodiment, when a user sets a plurality of ROI regions for the ROI setting unit 1020, the inverse wavelet transform may not be performed on all ROI regions to the end but be aborted at a different stage for each of the ROI regions. By this, each ROI region can be enlarged based on the various levels of resolution and the image quality of each ROI region can differ.

In the above-mentioned eighth embodiment, by zero-substituting the low-order bits of the wavelet transform coefficients obtained after decoding the coded image, the ROI region and the non-ROI region are made have different image qualities. In this respect, if each coding pass is independently encoded, a method for aborting variable-length decoding on the way can be applied. In JPEG2000 scheme, three types of processing passes that are S pass (significance propagation pass), R pass (magnitude refinement pass) and C pass (cleanup pass) are used for each coefficient bit within a bit-plane. In S pass, insignificant coefficients each surrounded by significant coefficients are decoded. In R pass, significant coefficients are decoded. In C pass, the remaining coefficients are decoded. Each processing pass has a degree of contribution to the image quality of an image increased in the order of S pass, R pass and C pass. The respective processing passes are executed in this order and the context of each coefficient is determined in consideration of information on the surrounding neighbor coefficients. By this method, since it is not necessary to zero-substitute, the processing amount can be reduced further.

Although the present invention has been described by way of exemplary embodiments, it should be understood that many other changes and substitutions may further be made by those skilled in the art without departing from the scope of the present invention which is defined by the appended claims.

What is claimed is:

1. An image processing apparatus comprising:
a region setting unit which sets a plurality of regions in an image;
an encoding unit which encodes data of the image in such a manner that each of the regions set by the region setting unit has a different image quality;
an image transformation unit which transforms the data of the image by performing a predetermined processing on the data of the image, a degree of the transformation being determined for each of the regions according to a level of the image quality of each of the regions encoded by the encoding unit; and
a display unit which displays on a display device the data of the image transformed by the image transformation unit.

2. The apparatus of claim 1, wherein the image transformation unit makes the degree of the transformation lower for the region with a higher level of the image quality and makes the degree of the transformation higher for the region with a lower level of the image quality.

3. The apparatus of claim 1, wherein the predetermined processing is filtering on the data of the image using a filter coefficient determined according to the degree of the transformation.

4. The apparatus of claim 1, wherein the predetermined processing is multiplying the data of the image by a coefficient determined according to the degree of the transformation.

5. The apparatus of claim 1, wherein the predetermined processing is substituting data of a specific pixel in the image with a constant value at a ratio determined according to the degree of the transformation.

6. The apparatus of claim 1, further comprising:
a decoding unit which decodes coded data obtained by the encoding unit; and
a selecting unit which selects the data of the image transformed by the image transformation unit to be input to the display unit, when the encoding unit encodes the image, and selects the data of the image decoded by the decoding unit to be input to the display unit, when the decoding unit decodes the coded data,
wherein when the decoded image data is input to the display unit, the display unit displays the image data on the display device.

7. The apparatus of claim 1, further comprising a motion detection unit which detects movement of an object of interest in the image, wherein the region setting unit makes a region containing the object follow the movement of the object.

8. The apparatus of claim 1, further comprising an input unit which receives a setting of at least one of position, size and image quality of the plurality of the regions.

9. The apparatus of claim 1, wherein the image transformation unit transforms the data of the image in such a manner that each of the regions has a different image quality.

10. The apparatus of claim 1, wherein the image transformation unit transforms the data of the image in such a manner that each of the regions has a different color.

11. The apparatus of claim 1, wherein the image transformation unit transforms the data of the image in such a manner that each of the regions has a different brightness.

12. The apparatus of claim 1, wherein the image transformation unit includes a means for shading on the image and transforms the data of the image in such a manner that each of the regions has a different shading density.

13. A shooting apparatus comprising:
a shooting unit which takes in an image;
a region setting unit which sets a plurality of regions in the image;
an encoding unit which encodes data of the image output from the shooting unit in such a manner that each of the regions set by the region setting unit has a different image quality;
an image transformation unit which transforms the data of the image output from the shooting unit by performing a predetermined processing on the data of the image, a degree of the transformation being determined for each of the regions according to a level of the image quality of each of the regions encoded by the encoding unit; and
a display unit which displays on a display device the data of the image transformed by the image transformation unit.

14. An image display apparatus comprising:
a display unit which displays an image;
a region setting unit which sets a region of interest for the image;
a region enlarging unit which enlarges the region of interest; and
a motion detection unit which detects movement of an object in the region of interest,
wherein the region setting unit moves the enlarged region of interest according to the movement of the object in the region of interest.

15. The apparatus of claim 14, wherein the region of interest is manually set for the image.

16. The apparatus of claim 14, wherein the region of interest is automatically set for the image by detecting the movement of the object in the image.

17. The apparatus of claim 14, further comprising an image transformation unit which makes the region of interest and other region have different image qualities.

18. The apparatus of claim 14, further comprising an image transformation unit which makes the region of interest and other region have different resolutions.

19. The apparatus of claim 14, wherein the region enlarging unit extracts data corresponding to the region of interest from the image and performs an enlargement processing on the extracted data, and preserves the data obtained by the enlargement processing separately from data of the image, and wherein the display unit reads the data preserved separately and displays an image based on the data preserved separately in the region of interest and a peripheral region thereof.

20. The apparatus of claim 14, wherein the region enlarging unit extracts data corresponding to the region of interest from the image and performs an enlargement processing on the extracted data, and overwrites data corresponding to the region of interest and a peripheral region thereof by data obtained by the enlargement processing, and wherein the display unit reads the overwritten data and displays an image based on the overwritten data.
